(19) United States
(12) Patent Application Publication
(10) Pub. No.: US 2009/0273743 A1
(43) Pub. Date: Nov. 5, 2009

(54) Liquid Crystal Display and Television Receiver

(76) Inventors: Daiichi Sawabe, Tsu-shi Mie (JP); Yohichiroh Sakaki, Suzuka-shi Mie (JP); Kenichi Iwamoto, Kobe-shi Hyogo (JP)

Correspondence Address: HARNESS, DICKEY & PIERCE, P.L.C., P.O. BOX 8910, RESTON, VA, 20195, US

(21) Appl. No.: 11/991,917

(22) PCT Filed: Sep. 28, 2006
(86) PCT No.: PCT/JP2006/319379

§ 371 Date: Mar. 12, 2008

(30) Foreign Application Priority Data
Sep. 30, 2005 (JP) 2005-289432

(51) Int. Cl. G02F 1/1347

(52) U.S. Cl. 349/81

(57) ABSTRACT

In one embodiment of the present invention, a liquid crystal display of the present invention contains an LCD (1) and an LCD (2). Adjacent pairs of polarizers form crossed Nicols. When the LCD (1) produces a display from a first display signal, the LCD (2) produces a display from a second display signal obtained from the first display signal. The gate driver for the LCD (1) and the gate driver for the LCD (2) producing a display from the second display signal are disposed symmetric. Accordingly, flickering is reduced which otherwise would be clearly visible when the two liquid crystal panels are stacked. A liquid crystal display with high display quality is thus realized.

### TECHNICAL FIELD

The present invention relates to liquid crystal displays with improved contrast and television receivers incorporating the devices.

### BACKGROUND ART

There exist various techniques for improving the contrast of a liquid crystal display. The following is examples disclosed in patent documents 1 to 7.

Patent document 1 discloses a technique of optimizing the relative amount and surface area ratio of the yellow component of pigment in a color filter to improve the contrast ratio. The technique successfully addresses the problem of poor contrast ratio of a liquid crystal display caused by pigment molecules in the color filter scattering and depolarizing polarized light. Patent document 1 states that the contrast ratio of a liquid crystal display improves from 280 to 420.

Patent document 2 discloses a technique of increasing the transmittance and polarizing capability of a polarizer to improve the contrast ratio. Patent document 2 states that the contrast ratio of a liquid crystal display improves from 200 to 250.

Patent documents 3 and 4 disclose a technique for improving contrast in guest-host mode which exploits absorption of light by a dichroic pigment.

Patent document 3 describes a method of improving contrast by way of a structure in which two guest-host liquid crystal cells are provided with a quarter-wave plate interposed between the two cells. Patent document 3 discloses omission of polarizers.

Patent document 4 discloses a liquid crystal display element in which a dichroic pigment is mixed with a liquid crystal used in dispersive liquid crystal mode. Patent document 4 states a contrast ratio of 101.

The techniques disclosed in patent documents 3 and 4 show relatively low contrast when compared to the other schemes. To further improve the contrast, various methods may be available: the light absorption by the dichroic pigment may be improved, the pigment content increased, or the thickness of the guest-host liquid crystal cell(s) increased. All these methods however lead to new problems, such as technical problems, poor reliability, and poor response properties.

Patent documents 5 and 6 disclose a method of improving contrast by an optical compensation scheme. The documents describe a liquid crystal panel and a liquid crystal display panel provided between a pair of polarizers. The liquid crystal panel performs optical compensation.

Patent document 5 improves a retardation contrast ratio from 14 to 35 in STN mode using a display cell and a liquid crystal cell which is provided to perform optical compensation.

Patent document 6 improves a contrast ratio from 8 to 100 by disposing a liquid crystal cell for optical compensation. The cell compensates for wavelength dependence of a liquid crystal display cell in, for example, TN mode when the display cell is displaying black.

Although the techniques disclosed in the patent documents achieve a 1.2- to 10-fold or even greater increase in contrast ratio, the absolute value of contrast ratio is no higher than about 35 to 420.

Another contrast enhancing technique is disclosed in patent document 7, for example. The document teaches a complex liquid crystal display in which two liquid crystal panels are stacked in such a manner that polarizers form crossed Nicols. Patent document 7 states that the stacking of two panels increases the contrast ratio to three to four digit values whilst the panel, if used alone, shows a contrast ratio of 100.

Patent document 1: Japanese Unexamined Patent Publication (Tokukai) 2001-188120 (published Jul. 10, 2001)
Patent document 2: Japanese Unexamined Patent Publication (Tokukai) 2002-90536 (published Mar. 27, 2002)
Patent document 3: Japanese Unexamined Patent Publication 63-25629/1988 (Tokukaisho 63-25629; published Feb. 3, 1988)
Patent document 4: Japanese Unexamined Patent Publication 5-2194/1993 (Tokukaihei 5-2194; published Jan. 8, 1993)
Patent document 5: Japanese Unexamined Patent Publication 64-49021/1989 (Tokukaisho 64-49021; published Feb. 23, 1989)
Patent document 6: Japanese Unexamined Patent Publication 2-23/1990 (Tokukaihei 2-23; published Jan. 5, 1990)
Patent document 7: Japanese Unexamined Patent Publication 5-88197/1993 (Tokukaihei 5-88197; published Apr. 9, 1993)

### DISCLOSURE OF INVENTION

Patent document 7 is aimed at achieving increased gray levels by stacking two liquid crystal panels without increasing the gray levels of the individual liquid crystal panels; no concrete measures are taken to address flickers which could seriously degrade display quality.

The present invention, conceived in view of these problems, has an objective of reducing flickers which markedly increase in occurrence when two liquid crystal panels are stacked, so as to realize a liquid crystal display with high display quality.

The liquid crystal display in accordance with the present invention, to address the problems, is characterized as follows. The liquid crystal display includes two or more stacked liquid crystal panels. At least some of structural elements involved in producing a display on a first liquid crystal panel and a second liquid crystal panel are disposed symmetric with respect to a point, a line, or a plane. One of adjacent liquid crystal panels of the stacked liquid crystal panels is the first liquid crystal panel, and the other is the second liquid crystal panel.

According to the arrangement, at least some of structural elements involved in producing a display on the first liquid crystal panel and the second liquid crystal panel are disposed symmetric with respect to a point, a line, or a plane. That layout enables the intensity of flickering to differ between the first liquid crystal panel and the second liquid crystal panel.

Accordingly, when the first liquid crystal panel and the second liquid crystal panel are combined, the intensity of flickering of the two panels is averaged out. Thus, the flickering of the panels as a whole is restrained.

Therefore, the display is capable of producing high quality images with reduced flickering.

Examples of the structural elements involved in producing a display may include source drive means, gate drive means, and pixel-driving TFTs or other like switching elements.

The source drive means may be arranged as follows.

The source drive means of the first liquid crystal panel and the source drive means of the second liquid crystal panel are disposed symmetric when the first liquid crystal panel and the second liquid crystal panel are combined.

The gate drive means may be arranged as follows.

The gate drive means of the first liquid crystal panel and the gate drive means of the second liquid crystal panel are disposed symmetric when the first liquid crystal panel and the second liquid crystal panel are combined.

The switching elements may be arranged as follows.

The switching and other structural elements for the pixels, connected to the pixel electrodes of the panels, are disposed symmetric when the first liquid crystal panel and the second liquid crystal panel are combined.

More specifically, the drivers of the liquid crystal panels may be mounted on either the top and bottom ends or the left and right sides of the first liquid crystal panel and the second liquid crystal panel when the first liquid crystal panel and the second liquid crystal panel are combined.

The description so far has been concerned with structural symmetry. The following description will be concerned with electrical symmetry, which is also effective in restraining flickering.

For example, by rendering the first display signal fed to the first liquid crystal panel and the second display signal fed to the second liquid crystal panel in opposite phase from each other, flickering is electrically restrained.

When the first liquid crystal panel and the second liquid crystal panel are combined, the display is capable of producing high quality images owing, as described in the foregoing, to flickering restraint achieved by arranging the structural elements of the panels electrically and structurally symmetric.

The stacked liquid crystal panels have polarized light absorbing layers provided to form crossed Nicols across the liquid crystal panels. Therefore, in the front direction, light leaks along the transmission axis of the polarized light absorbing layer, but the leak is blocked off by the absorption axis of the next polarized light absorbing layer. At oblique angles, if the Nicol angle, or the angle at which the polarization axes of the adjacent polarized light absorbing layers intersect, deviates somewhat from an original design, no increase in light intensity due to light leakage occurs. Black is less likely to lose its depth with an increase in the Nicol angle at oblique viewing angles.

From the foregoing, when two or more liquid crystal panels are stacked, there are provided at least three polarized light absorbing layers. The three polarized light absorbing layers disposed to form crossed Nicols allow for a greatly improved shutter performance both in the front and oblique directions. That in turn greatly improves contrast.

Therefore, high contrast, flicker free, high quality images can be provided.

The liquid crystal display of the present invention may be used as a display in a television receiver containing: a tuner section for receiving television broadcast; and a display for displaying the television broadcast received by the tuner section.

Accordingly, high contrast, high quality television broadcast can be displayed with restrained flickering.

### BRIEF DESCRIPTION OF DRAWINGS

FIG. 1 is a schematic cross-sectional view of a liquid crystal display, illustrating an embodiment of the present invention.

FIG. 2 illustrates the positional relationship of polarizers and panels in the liquid crystal display shown in FIG. 1.

FIG. 3 is a plan view of a pixel electrode and its neighborhood in the liquid crystal display shown in FIG. 1.

FIG. 4 is a schematic structural diagram of a drive system which drives the liquid crystal display shown in FIG. 1.

FIG. 5 illustrates connections between drivers and panel drive circuits in the liquid crystal display shown in FIG. 1.

FIG. 6 is a schematic structural diagram of a backlight provided in the liquid crystal display shown in FIG. 1.

FIG. 7 is a block diagram of a display controller, a drive circuit which drives the liquid crystal display shown in FIG. 1.

FIG. 8 is a schematic cross-sectional view of a liquid crystal display with a single liquid crystal panel.

FIG. 9 illustrates the positional relationship of polarizers and panels in the liquid crystal display shown in FIG. 8.

FIG. 10(a) illustrates a contrast improvement mechanism.

FIG. 10(b) illustrates a contrast improvement mechanism.

FIG. 10(c) illustrates a contrast improvement mechanism.

FIG. 11(a) illustrates a contrast improvement mechanism.

FIG. 11(b) illustrates a contrast improvement mechanism.

FIG. 11(c) illustrates a contrast improvement mechanism.

FIG. 11(d) illustrates a contrast improvement mechanism.

FIG. 12(a) illustrates a contrast improvement mechanism.

FIG. 12(b) illustrates a contrast improvement mechanism.

FIG. 12(c) illustrates a contrast improvement mechanism.

FIG. 13(a) illustrates a contrast improvement mechanism.

FIG. 13(b) illustrates a contrast improvement mechanism.

FIG. 14(a) illustrates a contrast improvement mechanism.

FIG. 14(b) illustrates a contrast improvement mechanism.

FIG. 14(c) illustrates a contrast improvement mechanism.

FIG. 15(a) illustrates a contrast improvement mechanism.

FIG. 15(b) illustrates a contrast improvement mechanism.

FIG. 16(a) illustrates a contrast improvement mechanism.

FIG. 16(b) illustrates a contrast improvement mechanism.

FIG. 17 shows a display pattern produced by a liquid crystal display to illustrate causes of flickers.

FIG. 18 is a graph representing changes in luminance in the display pattern, shown in FIG. 17, produced by a liquid crystal display.

FIG. 19 illustrates a relationship between the values of Vcom applied to a liquid crystal display and a flickering area.

FIG. 20 illustrates a relationship between the values of Vcom applied to a liquid crystal display and flickering areas.

FIG. 21 illustrates a relationship between the values of Vcom applied to a liquid crystal display and a flickering area.

FIG. 22 is a graph representing a relationship between optimal values of Vcom for a liquid crystal display and on-screen positions.

FIG. 23 illustrates an equivalent circuit to pixels in a liquid crystal display.

FIG. 24 is a signal waveform diagram at a near end of a gate in a liquid crystal display.

FIG. 25 is a signal waveform diagram at a far end of a gate in a liquid crystal display.

FIG. 26 is a schematic cross-sectional view of a liquid crystal display on which an anti-flickering scheme is implemented.

FIG. 27(a) is a diagram illustrating a flicker cancelling mechanism.

FIG. 27(b) is a diagram illustrating a flicker cancelling mechanism.

FIG. 27(c) is a diagram illustrating a flicker cancelling mechanism.

FIG. 28(a) is a diagram illustrating a specific flicker cancelling configuration.

FIG. 28(b) is a diagram illustrating a specific flicker cancelling configuration.

FIG. 28(c) is a diagram illustrating a specific flicker cancelling configuration.

FIG. 28(d) is a diagram illustrating a specific flicker cancelling configuration.

FIG. 29 is a schematic illumination of the structure of a pixel including liquid crystal in a liquid crystal display.

FIG. 30(a) is an illustration of a liquid crystal display of an embodiment of the present invention.

FIG. 30(b) is an illustration of a liquid crystal display of an embodiment of the present invention.

FIG. 30(c) is an illustration of a liquid crystal display of an embodiment of the present invention.

FIG. 31(a) is an illustration of the liquid crystal display shown in FIG. 30(a).

FIG. 31(b) is an illustration of the liquid crystal display shown in FIG. 30(a).

FIG. 31(c) is an illustration of the liquid crystal display shown in FIG. 30(a).

FIG. 32 illustrates a delay of a gate signal.

FIG. 33 illustrates a relationship between the positions of gate drive means in two liquid crystal panels and values of Vcom.

FIG. 34 is a schematic block diagram of a drive control circuit for the liquid crystal display shown in FIG. 30(a).

FIG. 35(a) is an illustration of a liquid crystal display of another embodiment of the present invention.

FIG. 35(b) is an illustration of a liquid crystal display of another embodiment of the present invention.

FIG. 35(c) is an illustration of a liquid crystal display of another embodiment of the present invention.

FIG. 36(a) is an illustration of the liquid crystal display shown in FIG. 35(a).

FIG. 36(b) is an illustration of the liquid crystal display shown in FIG. 35(a).

FIG. 36(c) is an illustration of the liquid crystal display shown in FIG. 35(a).

FIG. 37 illustrates a delay of a source signal.

FIG. 38 illustrates a relationship between the positions of source drive means in two liquid crystal panels and values of Vcom.

FIG. 39 is a schematic block diagram of a drive control circuit for the liquid crystal display shown in FIG. 35(a).

FIG. 40 illustrates an equivalent circuit to pixels in a liquid crystal display of another embodiment of the present invention.

FIG. 41 is a graph representing a relationship between optimal values of Vcom and gray level voltage.

FIG. 42 illustrates how flickering develops.

FIG. 43 is a schematic cross-sectional view of a liquid crystal display on which an anti-flickering scheme is implemented.

FIG. 44 illustrates a flicker cancelling mechanism.

FIG. 45 illustrates a driving method for two panels in which the polarity of application voltage is inverted.

FIG. 46 is a schematic block diagram of a liquid crystal display in which the panel driving method shown in FIG. 45 is implemented.

FIG. 47 illustrates an example of mounting drive circuit boards to typical two liquid crystal panels.

FIG. 48 illustrates an example of mounting drive circuit boards to the two liquid crystal panels of the present invention.

FIG. 49 illustrates an example of mounting drive circuit boards to the two liquid crystal panels of the present invention.

FIG. 50 illustrates an example of mounting drive circuit boards to typical two liquid crystal panels.

FIG. 51 illustrates an example of mounting drive circuit boards to the two liquid crystal panels of the present invention.

FIG. 52 is a schematic block diagram of a television receiver incorporating the liquid crystal display of the present invention.

FIG. 53 is a block diagram illustrating a relationship between a tuner section and a liquid crystal display in the television receiver shown in FIG. 52.

FIG. 54 is an exploded perspective view of the television receiver shown in FIG. 52.

### BEST MODE FOR CARRYING OUT INVENTION

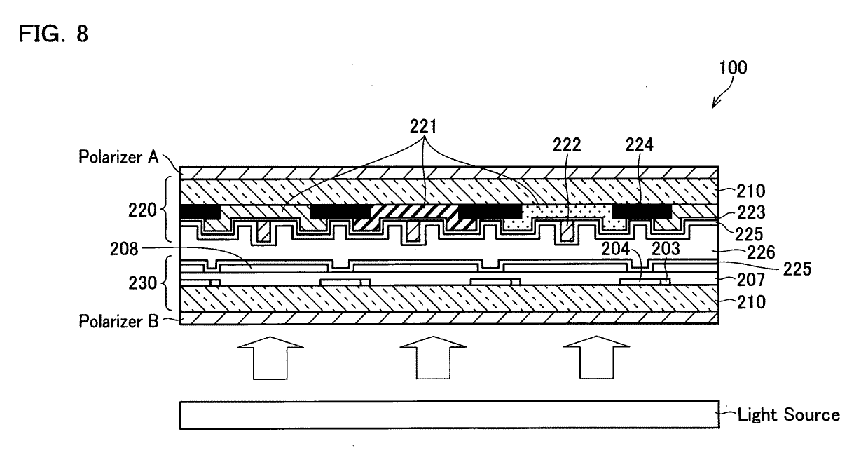

Referring to FIG. 8, a typical liquid crystal display contains a liquid crystal panel and polarizers A, B attached to the panel. The panel contains a color filter substrate and a driver substrate. The description here will focus on the MVA (multidomain vertical alignment) liquid crystal display.

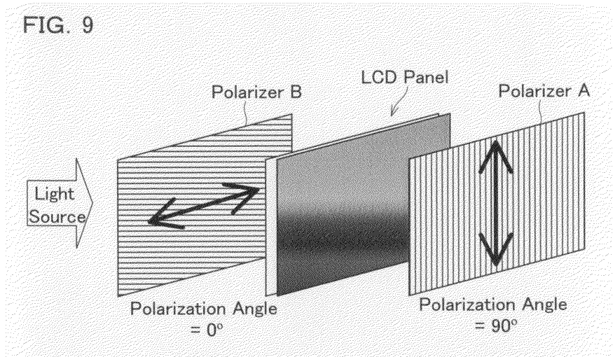

The polarizers A, B, as shown in FIG. 9, are positioned so that their polarization axes are orthogonal to each other. The azimuth of the direction in which the liquid crystal aligns when a threshold voltage is applied to pixel electrodes 208 (FIG. 8) is set to 45° with respect to the polarization axes of the polarizers A, B. Under these conditions, the liquid crystal layer in the liquid crystal panel rotates the axis of incident light which has been polarized by the polarizer A; the light thus comes out of the polarizer B. When the voltage applied to the pixel electrodes is less than or equal to the threshold voltage, the liquid crystal aligns vertical to the substrate. The polarization angle of the incident light does not change, producing a black display. In MVA mode, the liquid crystal under applied voltage aligns in four directions (multidomain) to deliver a large viewing angle.

Vertical alignment refers to a state in which liquid crystal molecules align in such a manner that their axes (axis orientation) point at about 85° or greater to the surface of a vertical alignment film.

Contrast improvement has a limit with the double polarizer structure shown in FIG. 9. The inventors of the present invention have found that three polarizers, disposed to form crossed Nicols, used in combination with two liquid crystal display panels provides an improved shutter performance both in the front and oblique directions.

The following will discuss a contrast improvement mechanism.

Specifically, the inventors have made the following findings.

### (1) Front Direction

Light leaked in the direction of the transmission axis of crossed Nicols due to depolarization (scattering of CF, for example) in the panel. In the triple polarizer structure, the third polarizer is positioned so that its absorption axis matches with the light leaking in the direction of the transmission axis of the second polarizer. The leakage is thus eliminated.

### (2) Oblique Directions

Changes in leakage become less sensitive to an increasing Nicol angle φ of a polarizer, that is, black is less likely to lose its depth with an increasing Nicol angle φ at oblique viewing angles.

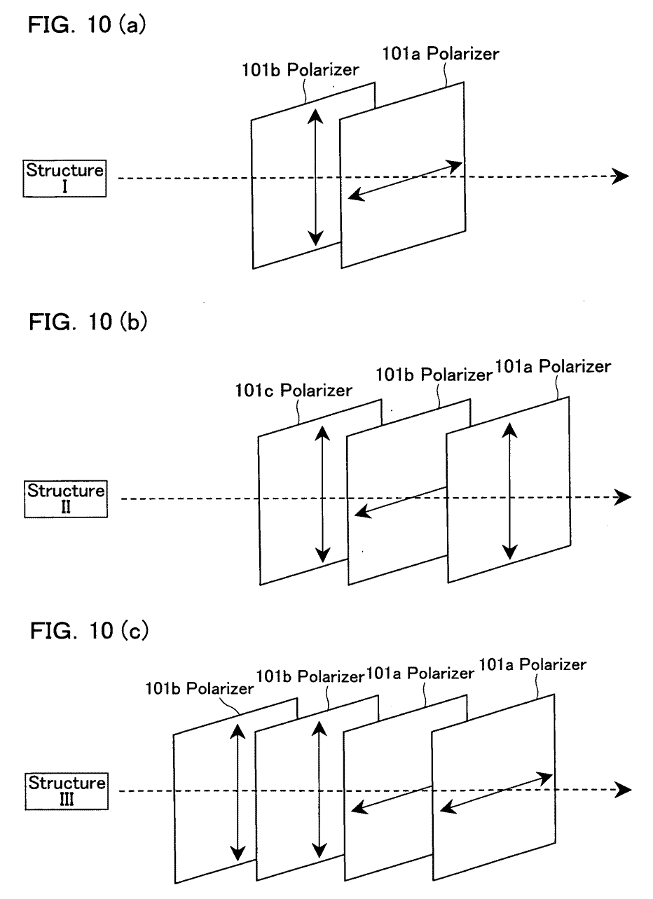

From these findings, the inventors have confirmed that the triple polarizer structure greatly improves the contrast of the liquid crystal display. The following will discuss a contrast improvement mechanism in reference to FIGS. 10(a) to 10(c), FIGS. 11(a) to 11(d), FIGS. 12(a) to 12(c), FIG. 13(a), FIG. 13(b), FIGS. 14(a) to 14(c), FIG. 15(a), FIG. 15(b), FIG. 16(a), FIG. 16(b), and Table 1. A double polarizer structure will be referred to as structure I, and a triple polarizer structure as structure II. The contrast improvements in oblique directions are attributable essentially to polarizer structure. The modeling here is based only on polarizers, involving no liquid crystal panel.

FIG. 10(a) depicts structure I with a single liquid crystal display panel, an example of two polarizers 101a, 101b disposed to form crossed Nicols. FIG. 10(b) depicts structure II, an example of three polarizers 101a, 101b, 101c disposed to form crossed Nicols. Since structure II includes two liquid crystal display panels, there are two pairs of polarizers which are disposed to form crossed Nicols. FIG. 10(c) depicts an example of a polarizer 101a and a polarizer 101b disposed face to face to form crossed Nicols; an additional polarizer of the same polarization direction is disposed outside each of the polarizers. Although FIG. 10(c) shows four polarizers, those polarizers which form crossed Nicols are only two of them that sandwich a liquid crystal display panel.

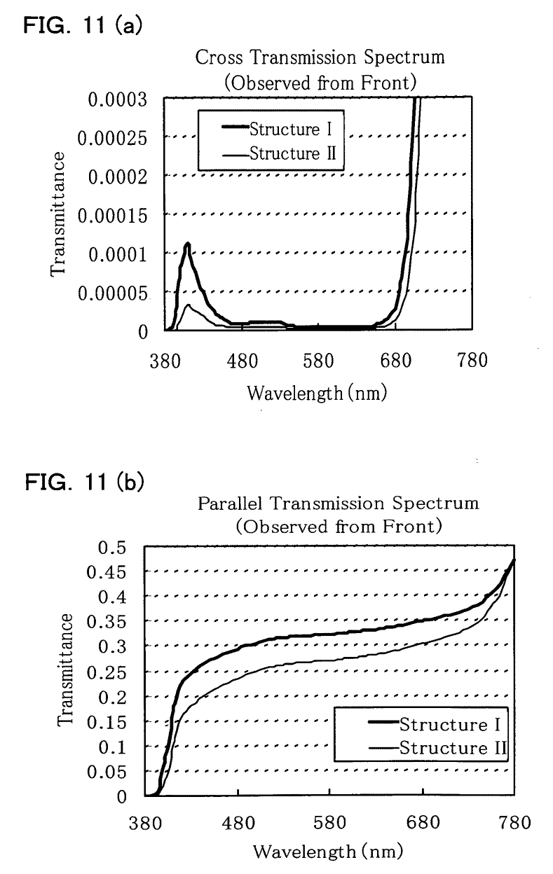

The transmittance at which the liquid crystal display panel produces a black display is modeled by treating that transmittance as the transmittance when polarizers are disposed to form crossed Nicols without a liquid crystal display panel, that is, a cross transmittance. The resultant transmittance model is referred to as a black display. Meanwhile, the transmittance at which the liquid crystal display panel produces a white display is modeled by treating that transmittance as the transmittance when polarizers are disposed to form parallel Nicols without a liquid crystal display panel, that is, a parallel transmittance. The resultant transmittance model is referred to as a white display. FIGS. 11(a) to 11(d) are graphs representing examples of the wavelength vs. transmittance relationship of a transmission spectrum when the polarizer is viewed from the front and at oblique angles. The modeled transmittances are ideal values of transmittances in white and black displays for polarizers disposed to form crossed Nicols which sandwiches the liquid crystal display panel.

FIG. 11(a) is a graph showing the wavelength vs. cross transmittance relationship of a transmission spectrum for structures I, II for comparison when polarizers are viewed from the front. The graph demonstrates that structures I, II exhibit similar transmittance properties when a black display is viewed from the front.

FIG. 11(b) is a graph showing the wavelength vs. parallel transmittance relationship of a transmission spectrum for structures I, II for comparison when polarizers are viewed from the front. The graph demonstrates that structures I, II exhibit similar transmittance properties when a white display is viewed from the front.

FIG. 11(c) is a graph showing the wavelength vs. cross transmittance relationship of a transmission spectrum for structures I, II for comparison when polarizers are viewed at oblique angles (azimuth=45°−polar angle 60°). The graph demonstrates that structure II exhibits an almost zero transmittance at many of the wavelengths shown, whilst structure I transmits a small amount of light at many of the wavelengths shown, when a black display is viewed at oblique angles. To put it differently, the double polarizer structure suffers light leakage (hence, loses crispness in blacks) when a black display is viewed at oblique viewing angles. On the other hand, the triple polarizer structure successfully restrains light leakage (hence, retains crispness in blacks) when a black display is viewed at oblique viewing angles.

FIG. 11(d) is a graph showing the wavelength vs. parallel transmittance relationship of a transmission spectrum for structures I, II for comparison when polarizers are viewed at oblique angles (azimuth=45°−polar angle 60°). The graph demonstrates that structures I, II exhibit similar transmittance properties when a white display is viewed at oblique angles.

As shown in FIGS. 11(b), 11(d), white appears almost the same regardless of the number of polarizers used, in other words, the number of Nicol pairs provided by polarizers and also regardless of whether the display is viewed from the front or at oblique angles.

However, as shown in FIG. 11(c), black appears less crisp on structure I (one Nicol pair) at oblique viewing angles, but remains crisp on structure II (two Nicol pairs) at oblique viewing angles.

Table 1 shows, as an example, the values of transmittance at 550 nm for the front and oblique angles (azimuth=45°−polar angle 60°).

TABLE 1
550 nm

| | Front | | | Oblique position (45° to 60°) | | |
|---|---|---|---|---|---|---|
| | Structure | Structure | | Structure | Structure | |
| | I | II | II/I | I | II | II/I |
| Parallel | 0.319 | 0.265 | 0832 | 0.274499 | 0.219084 | 0.798 |
| Crossed | 0.000005 | 0.000002 | 0.4 | 0.01105 | 0.000398 | 0.0360 |
| Parallel/Crossed | 63782 | 132645 | 2.1 | 24.8 | 550.5 | 22.2 |

In Table 1, “Parallel” denotes parallel transmittance, or the transmittance in white display; “Cross” denotes cross transmittance, or the transmittance in black display; and “Parallel/Cross” therefore denotes contrast.

Table 1 demonstrates that the contrast for the front on structure II is about twice as high as that on structure I and also that the contrast for oblique angles on structure II is about 22 times as high as that on structure I. The contrast for oblique angles shows great improvements.

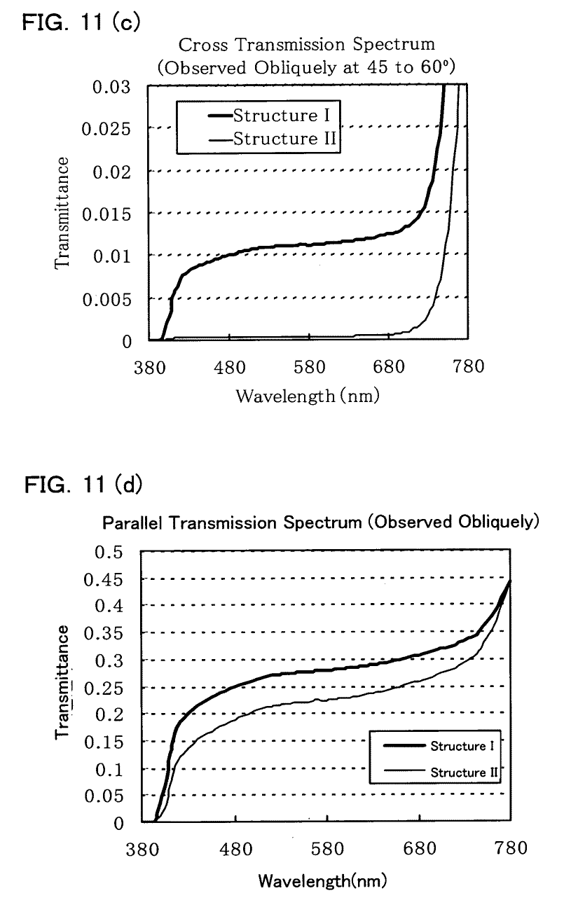

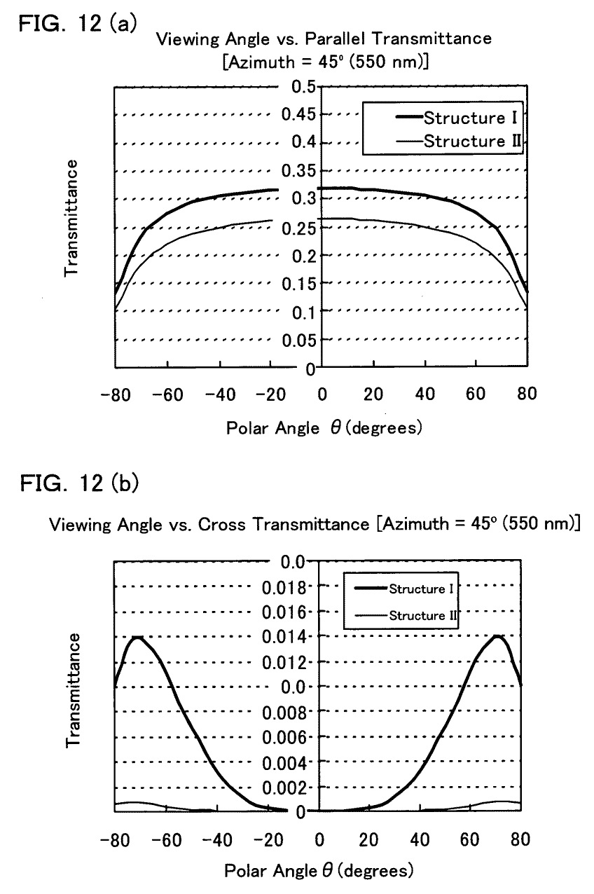

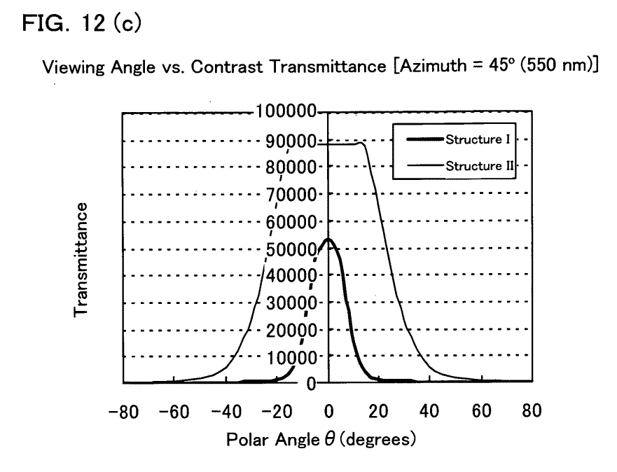

Now, referring to FIGS. 12(a) to 12(c), viewing angle performance will be described for white display and black display. Assume in the description an azimuth of 45° with respect to polarizers and a wavelength of 550 nm.

FIG. 12(a) is a graph representing the relationship between the polar angle and the transmittance in white display. The graph demonstrates that structures I and II share similar viewing angle performance (parallel viewing angle performance), albeit structure II exhibits a lower transmittance than structure I across the range.

FIG. 12(b) is a graph representing the relationship between the polar angle and the transmittance in black display. The graph demonstrates that structure II well restrains the transmittance at oblique viewing angles (near polar angle ±80°). On the other hand, structure I exhibits an increased transmittance at oblique viewing angles. At oblique viewing angles, blacks appear markedly less crisp on structure I than on structure II.

FIG. 12(c) is a graph representing the relationship between the polar angle and the contrast. The graph demonstrates that structure II exhibits far better contrast than structure I. The graph for structure II in FIG. 12(c) is “clipped off” near 0°. This particular part of the graph is actually a smooth curve; it is clipped because the transmittance for black drops so sharply by orders of magnitude and renders calculation impractical.

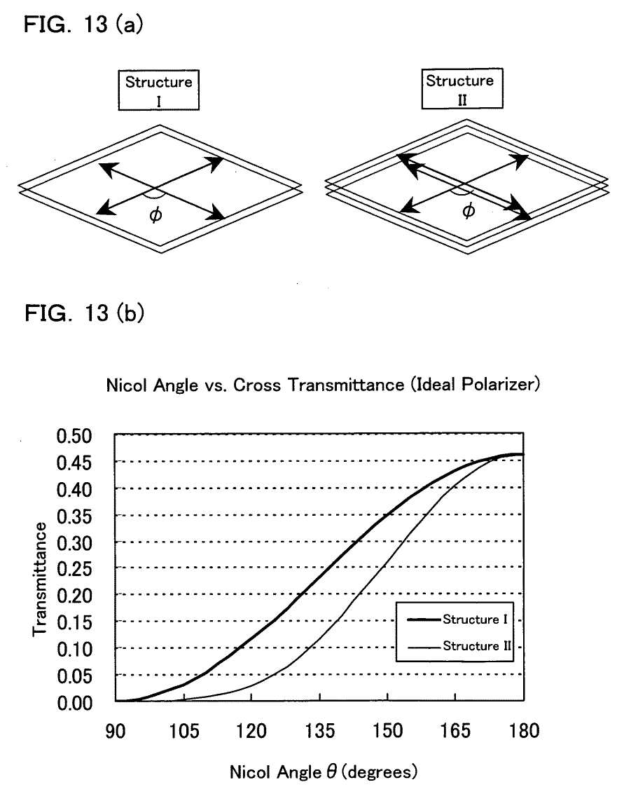

Next will be described the phenomenon that changes in leakage become less sensitive to an increasing Nicol angle φ of a polarizer, that is, black is less likely to lose its crispness with an increasing Nicol angle φ at oblique viewing angles, in reference to FIGS. 13(a), 13(b). The polarizer Nicol angle φ is an angle in a state that, as shown in FIG. 13(a), the polarization axes of the oppositely positioned polarizers are skew. FIG. 13(a) is a perspective view of polarizers which are positioned to form crossed Nicols; the figure shows the Nicol angle φ deviating from 90° (the deviation is the change in the Nicol angle).

FIG. 13(b) is a graph representing the relationship between the Nicol angle φ and the cross transmittance. Calculations are carried out based on an ideal polarizer (parallel Nicol transmittance=50%; crossed Nicol transmittance=0%). The graph demonstrates that the transmittance changes less with a change in the Nicol angle φ in structure II than in structure I in producing black display. In other words, the triple polarizer structure is less affected by a change in the Nicol angle φ than the double polarizer structure.

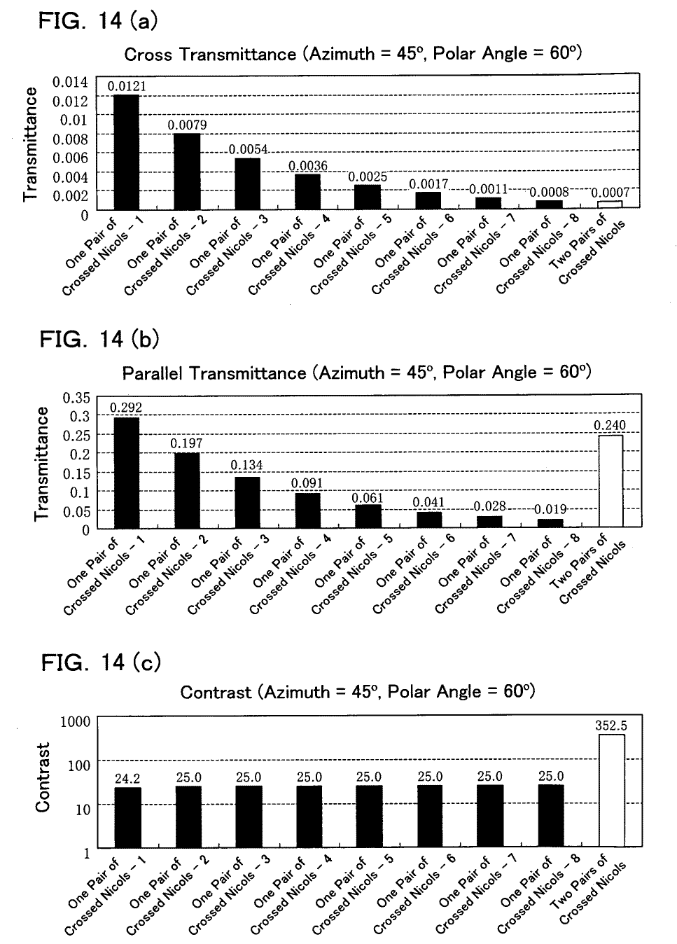

Next, the thickness dependence of the polarizer will be described in reference to FIGS. 14(a) to 14(c). The thickness of the polarizer is adjusted as in structure III in which, as shown in FIG. 10(c), polarizers of the same polarization axis direction are added one by one on a pair of crossed Nicols polarizers. FIG. 10(c) shows an example of a pair of crossed Nicols polarizers 101a, 101b with another pair of polarizers 101a, 101b of the same polarization axis direction sandwiching the first pair. In this case, the structure contains a pair of crossed Nicols polarizers and two other polarizers; thus, “one crossed pair −2.” Likewise, with each additional polarizer, “one crossed pair −3,” “one crossed pair −4,” . . . To draw the graphs in FIGS. 14(a) to 14(c), measurements are made on an assumption that azimuth=45° and polar angle=60°.

FIG. 14(a) is a graph representing the relationship between the thickness and the transmittance (cross transmittance) of a pair of crossed Nicols polarizers in producing black display. The graph also shows a transmittance for a structure with two pairs of crossed Nicols polarizers for comparison.

FIG. 14(b) is a graph representing the relationship between the thickness and the transmittance (parallel transmittance) of a pair of crossed Nicols polarizers in producing white display. The graph also shows a transmittance for a structure with two pairs of crossed Nicols polarizers for comparison.

The graph in FIG. 14(a) demonstrates that stacking polarizers reduces the transmittance in black display. Meanwhile, the graph in FIG. 14(b) demonstrates that stacking polarizers reduces the transmittance in white display. Simply stacking polarizers for the sake of prevention of reduced crispness in black display leads, undesirably, a decrease in the transmittance in white display.

FIG. 14(c) is a graph representing the relationship between the thickness and the contrast of a pair of crossed Nicols polarizers. The graph also shows contrast for two pairs of crossed Nicols polarizers for comparison.

As discussed above, the graphs in FIGS. 14(a) to 14(c) demonstrate that the structure with two pairs of crossed Nicols polarizers restrains loss of crisp blacks in black display and at the same time prevents reduced transmittance in white display. Besides, the two pairs of crossed Nicols polarizers consist of three polarizers; the pairs improve contrast by large amounts, as well as do not add to the total thickness of the liquid crystal display.

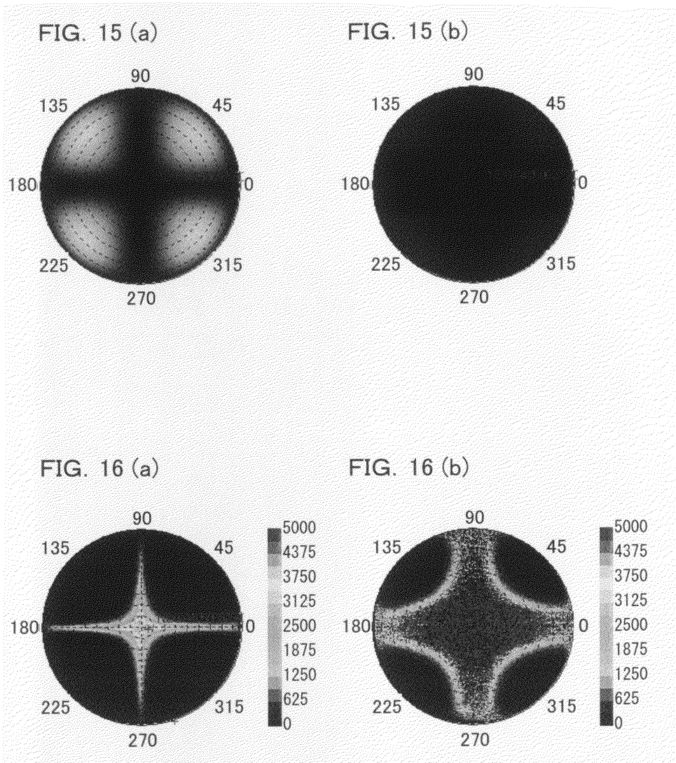

FIGS. 15(a), 15(b) show viewing angle characteristics of crossed Nicol transmittance in a specific manner. FIG. 15(a) shows the viewing angle characteristics of crossed Nicols in structure I, i.e., a double polarizer structure with a pair of crossed Nicols. FIG. 15(b) shows the viewing angle characteristics of crossed Nicols in structure II, i.e., a triple polarizer structure with two pairs of crossed Nicols.

The diagrams in FIGS. 15(a), 15(b) demonstrate that the structure with two pairs of crossed Nicols is almost free from degrading crispness in blacks (attributable to little increase in the transmittance in black display). This advantage of the structure is evident at 45°, 135°, 225°, and 315°.

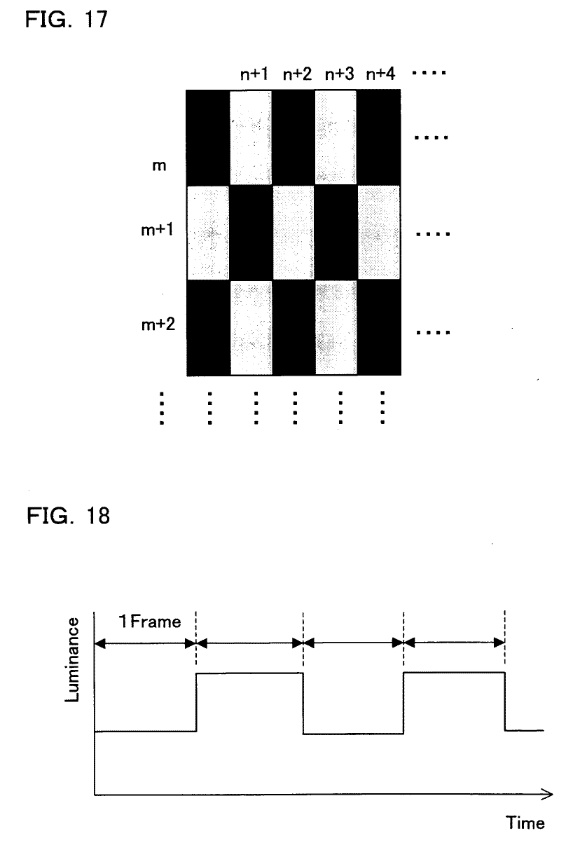

FIGS. 16(a), 16(b) show viewing angle characteristics of contrast (parallel/cross luminance) in a specific manner. FIG. 16(a) shows the viewing angle characteristics of contrast in structure I, i.e., a double polarizer structure with a pair of crossed Nicols. FIG. 16(b) shows the viewing angle characteristics of contrast in structure II, i.e., a triple polarizer structure with two pairs of crossed Nicols.

The diagrams in FIGS. 16(a), 16(b) demonstrate that the structure with two pairs of crossed Nicols exhibits improved contrast than the structure with a pair of crossed Nicols.

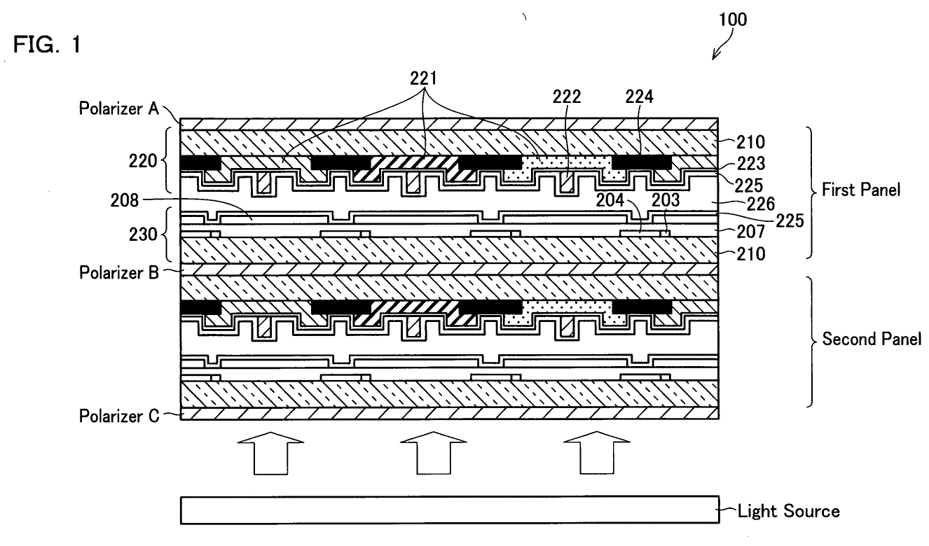

Now, referring to FIGS. 1 to 9, the following will describe this contrast improvement mechanism being applied to the liquid crystal display. For simplicity, two liquid crystal panels are used.

FIG. 1 is a schematic cross-section of a liquid crystal display 100 in accordance with the present embodiment.

The liquid crystal display 100 includes panels and polarizers being stacked alternately on top of each other as shown in FIG. 1. The two panels are termed a first and a second. The three polarizers are denoted by A, B, and C.

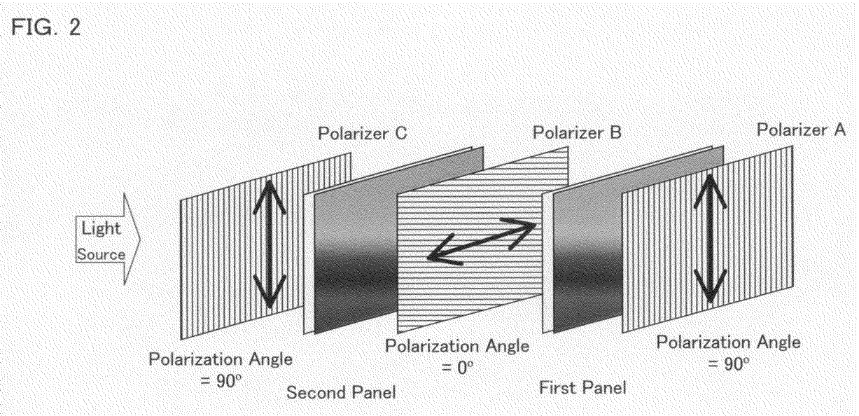

FIG. 2 is an illustration of the joining of the polarizers and the liquid crystal panels in the liquid crystal display 100 shown in FIG. 1. In FIG. 2, the polarizers A, B, C are positioned so that the polarization axis of the polarizer B is perpendicular to those of the polarizers A, C. The polarizers A and B form a pair of crossed Nicols, and the polarizers B and C form another pair.

Each of the first and second panels is a pair of transparent substrates (a color filter substrate 220 and an active matrix substrate 230) with liquid crystal being sealed in between. Each panel has a means of switching between a state in which the polarized light incident to the polarizer A from the light source is rotated by about 90°, a state in which the polarized light is not rotated, and any intermediate states as desired, by electrically changing the alignment of the liquid crystal.

The first and second panels each have a color filter and is capable of producing an image using a plurality of pixels. This display function is achieved by some display modes: TN (twisted nematic) mode, VA (vertical alignment) mode, IPS (in-plain switching) mode, FFS (fringe field switching) mode, and combinations of these modes. Among these modes, VA is suitable because the mode exhibits high contrast without combining with any other modes. Although the description here will focus on MVA (multidomain vertical alignment) mode, IPS and FFS modes are also sufficiently effective because both operate in normally black mode. The liquid crystal is driven by active matrix driving using TFTs (thin film transistors). For a detailed description of MVA manufacturing methods, see Japanese Unexamined Patent Publication 2001-83523 (Tokukaihei 2001-83523), for example.

The first and second panels in the liquid crystal display 100 have the same structure. Each panel includes a color filter substrate 220 and an active matrix substrate 230 positioned face to face as mentioned above and also contains spacers (not shown) to maintain the substrates at a specific distance from each other. The spacers are, for example, plastic beads or resin columns erected on the color filter substrate 220. Liquid crystal is sealed between the two substrates (the color filter substrate 220 and the active matrix substrate 230). A vertical alignment film 225 is formed on the surface of each substrate which comes in contact with the liquid crystal. The liquid crystal is nematic liquid crystal with negative dielectric anisotropy.

The color filter substrate 220 includes a transparent substrate 210 with a color filters 221, a black matrix 224, and other components built on the substrate 210. The substrate 220 is provided also with alignment controlling projections 222 which control the alignment direction of the liquid crystal.

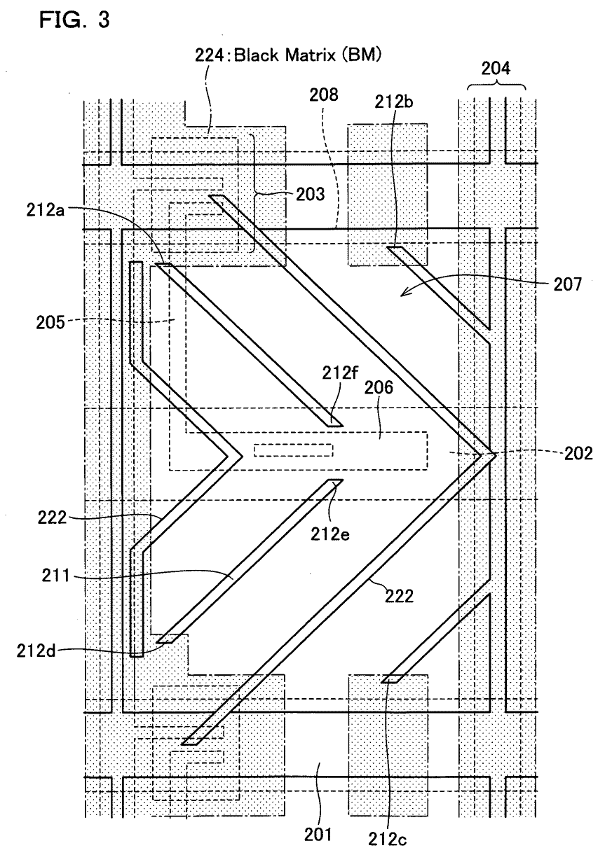

The active matrix substrate 230 includes, as shown in FIG. 3, a transparent substrate 210 with TFT elements 203, pixel electrodes 208, and other components built on the substrate 210. The substrate 230 is provided also with alignment control slit patterns 211 which controls the alignment direction of the liquid crystal. Note that the alignment controlling projections 222 and the black matrix 224 shown in FIG. 3 are projection of real patterns formed on the color filter substrate 220 onto the active matrix substrate 230. The black matrix 224 blocks unnecessary light which, if transmitted, would degrade display quality. As a threshold or higher voltage is applied to the pixel electrodes 208, liquid crystal molecules fall perpendicular to the projections 222 and the slit patterns 211. In the present embodiment, the projections 222 and the slit patterns 211 are formed so that liquid crystal molecules align at an azimuth of 45° with respect to the polarization axis of the polarizer.

As described in the foregoing, the first and second panels are constructed so that the red (R), green (G), and blue (B) pixels of one of the color filters 221 are positioned to match those of the other color filter 221 when viewed normal to the panels. Specifically, the R pixels of the first panel are positioned to match those of the second panel; the G pixels of the first panel are positioned to match those of the second panel; and the B pixels of the first panel are positioned to match those of the second panel, when viewed normal to the panels.

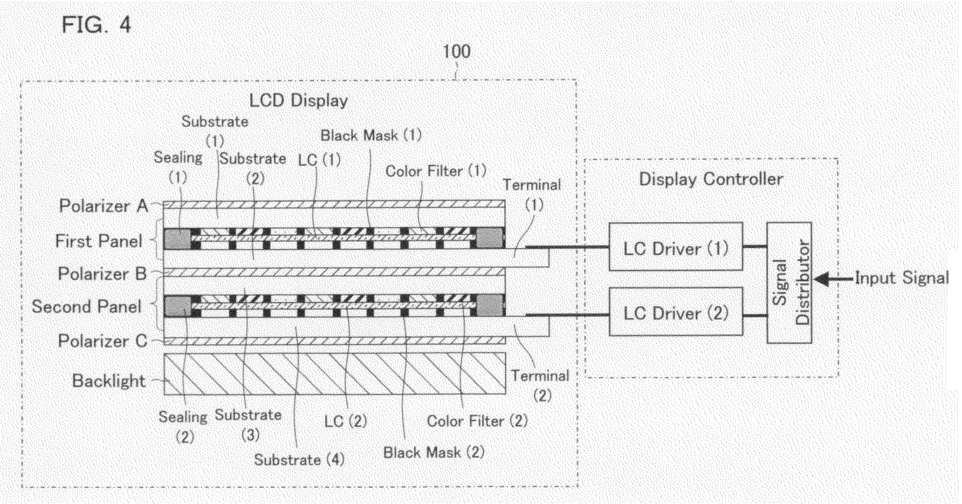

FIG. 4 is a schematic of a drive system for the liquid crystal display 100 constructed as above.

The drive system contains a display controller required to display video on the liquid crystal display 100.

As a result, the liquid crystal panel is capable of outputting suitable images according to input signals.

The display controller contains a first and a second panel drive circuit (1), (2) which drive the first and the second panel respectively with predetermined signals. The display controller also contains a signal distribution circuit section which distributes video source signals to the first and second panel drive circuits (1), (2).

The input signals refer not only to video signals from a TV receiver, VTR, or DVD player, but also to those produced by processing these signals.

Therefore, the display controller is adapted to send signals to the panels in such a manner that the liquid crystal display 100 can display suitable images.

The display controller sends suitable electric signals to the panels according to incoming video signals and is composed of drivers, circuit boards, panel drive circuits, and other components.

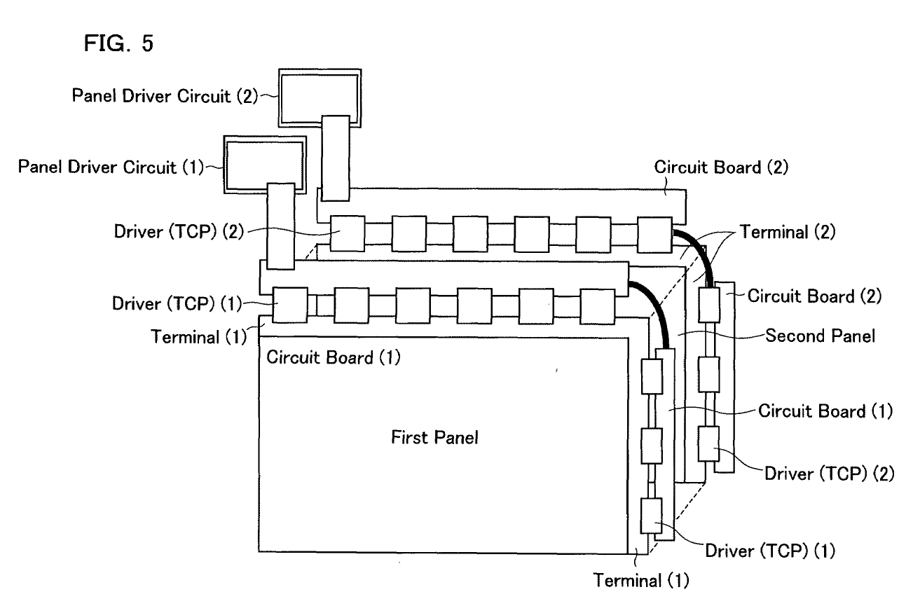

FIG. 5 illustrates connections between the first and second panels and the respective panel drive circuits. The polarizers are omitted in FIG. 5.

The first panel drive circuit (1) is connected via a driver (TCP) (1) to terminals (1) provided on the circuit board (1) of the first panel. In other words, the driver (TCP) (1) is connected to the first panel, coupled by the circuit board (1), and connected to the panel drive circuit (1).

The second panel drive circuit (2) is connected to the second panel in the same manner as the first panel drive circuit (1) is to the first panel; no further description is given.

Next will be described an operation of the liquid crystal display 100 constructed as above.

The pixels in the first panel are driven according to display signals. The corresponding pixels in the second panel (those which appear overlapping the pixels in the first panel when viewed normal to the panels) are driven in association with the first panel. When the combination of the polarizer A, the first panel, and the polarizer B (construction 1) transmits light, so does the combination of the polarizer B, the second panel, and the polarizer C (construction 2); when construction 1 does not transmit light, nor does the construction 2.

The first and second panels may be fed with identical image signals or associated, but different signals.

Next will be described a manufacturing method for the active matrix substrate 230 and the color filter substrate 220.

A manufacturing method for the active matrix substrate 230 will be first described.

Metal films (e.g. Ti/Al/Ti) are stacked by sputtering on a transparent substrate 10 to form scan signal lines (gate wires, gate lines, gate voltage lines, or gate bus lines) 201 and auxiliary capacitance lines 202 as shown in FIG. 3. A resist pattern is formed on the films by photolithography and dry etched in an etching gas (e.g. chlorine-based gas) to remove the resist. That simultaneously forms the scan signal lines 201 and the auxiliary capacitance lines 202 on the transparent substrate 210.

Thereafter a gate insulating film is formed of a silicon nitride (SiNx) and other materials, an active semiconductor layer is formed of amorphous silicon and other materials, and a low resistance semiconductor layer is formed of amorphous silicon and other materials doped with, for example, phosphor, all by CVD. Then, metal films (e.g. Al/Ti) are stacked by sputtering to form data signal lines (source wires, source lines, source voltage lines, or source bus lines) 204, drain lead-out lines 205, and auxiliary capacitance forming electrodes 206. A resist pattern is formed on the films by photolithography and dry etched in an etching gas (e.g. chlorine-based gas) to remove the resist. That simultaneously forms the data signal lines 204, the drain lead-out lines 205, and the auxiliary capacitance forming electrodes 206.

An auxiliary capacitance is formed between an auxiliary capacitance line 202 and an auxiliary capacitance forming electrode 206 with an intervening gate insulating film about 4000 angstrom thick.

Thereafter, the low resistance semiconductor layer is dry etched, for example, in a chlorine gas to form TFT elements 203 and thus separate the sources from the drains.

Next, an interlayer insulating film 207 of, for example, an acrylic-based photosensitive resin is formed by spin coating. Contact holes (not shown) which electrically connect the drain lead-out lines 205 to the pixel electrodes 208 are formed by photolithography. The interlayer insulating film 207 is about 3-μm thick.

Furthermore, pixel electrodes 208 and a vertical alignment film (not shown) are formed in this order to complete the manufacture.

The present embodiment is an MVA liquid crystal display as mentioned earlier and has slit patterns 211 in the pixel electrodes 208 made of ITO and other materials. Specifically, a film is formed by sputtering, followed by a resist pattern being formed by photolithography. Then, etching is carried out in an etching solution, e.g. iron(III) chloride, to form pixel electrode patterns as shown in FIG. 3.

That concludes the manufacture of the active matrix substrate 230.

The reference numerals 212a, 212b, 212c, 212d, 212e, 212f in FIG. 3 represent electrical connection sections of the slit in the pixel electrode 208. In the electrical connection sections of the slit, alignment is disturbed, resulting in alignment anomaly. Besides, a positive voltage is applied to the gate wire (slits 212a to 212d) to turn on the TFT element 203 generally for periods on the order of microseconds, whereas a negative voltage is applied to turn off the TFT element 203 generally for periods on the order of milliseconds; a negative voltage is applied for most of the time. Thus, if the slits 212a to 212d are disposed on the gate wires, ionic impurities contained in the liquid crystal may concentrate due to a gate negative DC application component. The alignment anomaly and ionic impurity concentration may cause the slits 212a to 212d to be spotted as display non-uniformities. The slits 212a to 212d therefore need to be disposed where they do not overlap the gate wires. The slits 212a to 212d are better hidden with the black matrix 224 as shown in FIG. 3.

Next will be described a manufacturing method for the color filter substrate 220.

The color filter substrate 220 contains a color filter layer, an opposite electrode 223, a vertical alignment film 225, and alignment controlling projections 222 on the transparent substrate 210. The color filter layer contains the color filters (three primary colors [red, green, and blue]) 221 and the black matrix (BM) 224.

First, a negative, acrylic-based photosensitive resin solution containing dispersed fine carbon particles is applied onto the transparent substrate 210 by spin coating and dried to form a black photosensitive resin layer. Subsequently, the black photosensitive resin layer is exposed to light using a photomask and developed to form the black matrix (BM) 224. The BM is formed so as to have respective openings for a first color layer (e.g. red layer), a second color layer (e.g. green layer), and a third color layer (e.g. blue layer) in areas where the first, second, and third color layers will be provided (the openings are provided corresponding to the pixel electrodes). More specifically, referring to FIG. 3, a BM pattern is formed like an island, and a light blocking section (BM) is formed on the TFT elements 203. The BM pattern shields from light anomalous alignment regions which occur in the slits 212a to 212d of electrical connection sections in the slit 212a to 212f in the pixel electrodes 208. The light blocking section prevents increases in leak current induced by external light hitting the TFT elements 203.

After applying a negative, acrylic-based photosensitive resin solution containing a dispersed pigment by spin coating, the solution is dried, exposed to light using a photomask, and developed to form a red layer.

The same steps are repeated to form the second color layer (e.g. green layer) and the third color layer (e.g. blue layer). That completes the manufacture of the color filters 221.

Furthermore, the opposite electrode 223 is formed of a transparent electrode, such as ITO, by sputtering. A positive, phenolnovolak-based photosensitive resin solution is then applied by spin coating. The solution is dried, exposed to light using a photomask, and developed to form the vertical alignment controlling projections 222. Then, columnar spacers (not shown) are formed to establish a cell gap for the liquid crystal panel by applying an acrylic-based photosensitive resin solution, exposing the solution to light using a photomask, and developing and curing the resin.

That completes the manufacture of the color filter substrate 220.

The present embodiment uses a BM made of resin. The BM may be made of a metal. The three primary colors of the color layers may not be red, green, and blue; they may be cyan, magenta, and yellow as an example, and there also may be provided a white layer.

Now, the color filter substrate 220 and the active matrix substrate 230 manufactured as above are joined to form a liquid crystal panel (first and second panels) by the following method.

First, a vertical alignment film 225 is formed on the surfaces of the color filter substrate 220 and the active matrix substrate 230 which come in contact with the liquid crystal. Specifically, before the formation of the alignment film, the substrate is baked for degassing and washed. The alignment film is then baked. After that, the substrate is washed and baked for degassing. The vertical alignment films 225 establish the alignment direction of the liquid crystal 226.

Next will be described a method for sealing the liquid crystal between the active matrix substrate 230 and the color filter substrate 220.

One of available liquid crystal sealing methods is vacuum injection, which is described here briefly: A thermosetting sealing resin is disposed around the substrate with an injection hole being left open for the injection of liquid crystal. The injection hole is immersed in liquid crystal in vacuum to drive out air from the closed space so that the liquid crystal can move in instead. Finally, the injection hole is sealed using, for example, a UV-setting resin. The vacuum injection however is undesirably time-consuming for the manufacture of a liquid crystal panel for vertical alignment mode, compared to the manufacture of a horizontal alignment panel. Dropwise liquid crystal dispensing/joining is employed here.

A UV-setting sealing resin is applied to the periphery of the active matrix substrate whilst liquid crystal is dispensed dropwise onto the color filter substrate. An optimal amount of liquid crystal is dispensed dropwise regularly inside the sealing so that the liquid crystal establishes a desired cell gap.

The pressure inside the joining device is reduced to 1 Pa to join the color filter substrate which has the sealing resin disposed thereon and the active matrix substrate which has the liquid crystal dispensed dropwise thereon. After the substrates are joined to each other at the low pressure, the pressure is changed back to the atmospheric pressure to collapse the sealing, leaving a desired gap in the sealing section.

The resultant structure with a desired cell gap in the sealing section is irradiated with UV radiation in a UV projection device for preliminary setting of the sealing resin. The structure is then baked in order to completely set the sealing resin. At this stage, the liquid crystal moves into every corner inside the sealing resin, filling up the cell. After the baking, the structure is separated into individual liquid crystal panels. That completes the manufacture of the liquid crystal panel.

In the present embodiment, the first and second panels are manufactured by the same process.

Next will be described the mounting of components to the first and second panels manufactured as above.

Here, the first and second panels are washed, and polarizers are attached to the panels. Specifically, polarizers A and B are attached respectively to the front and the back of the first panel as shown in FIG. 4. A polarizer C is attached to the back of the second panel. The polarizers may be stacked together with other layers, such as optical compensation sheets, where necessary.

Then drivers (liquid crystal driver LSI) are connected. Here, the drivers are connected using TCPs (tape career packages).

For example, an ACF (anisotropic conductive film) is attached to the terminals (1) of the first panel by preliminary compression as shown in FIG. 5. The TCPs (1) carrying the drivers are punched out of the carrier tape, aligned with panel terminal electrodes, and heated for complete compression/attachment. Thereafter, the input terminals (1) of the TCPs (1) are connected to the circuit board (1) using an ACF. The circuit board (1) is provided to couple the driver TCPs (1) together.

Next, two panels are joined. The polarizer B has an adhesive layer on each side. The surface of the second panel is washed, and the laminates of the adhesive layers of the polarizer B on the first panel are peeled off. The first and second panels, after being precisely aligned, are joined. Bubbles may be trapped between the panel and the adhesive layer during the joining process; it is therefore desirable to join the panels in vacuum.

Alternatively, the panels may be joined by another method as follows. An adhesive agent which sets at normal temperature or at a temperature not exceeding the panel's thermal resistance temperature (e.g. epoxy adhesive agent) is applied to the periphery of the panels. Plastic spacers are scattered, and, for example, fluorine oil is sealed. Preferred materials are optically isotropic liquids with a refractive index close to that of a glass substrate and as stable as liquid crystal.

The present embodiment is applicable to cases where the terminal face of the first panel and that of the second panel are at the same position as illustrated in FIGS. 4 and 5. The terminals may be disposed in any direction with respect to the panel and attached to the panel by any method. For example, they may be fixed mechanically without using adhesive.

To reduce the parallax caused by the thickness of the internal glass, the substrates of the two panels which face each other are preferably reduced in thickness to a minimum.

If glass substrates are used, thin substrates are straightly available on the market. Feasible substrate thicknesses may vary from one manufacturing line to another and depending on the dimensions of the liquid crystal panel and other conditions. An example is 0.4-mm thick glass for inner substrates.

The glass may be polished or etched. Glass can be etched by publicly known techniques (e.g. Japanese Patents 3524540 and 3523239). Typically, a chemical treatment solution such as a 15% aqueous solution of hydrofluoric acid is used. Any parts which should not be etched including the terminal face are coated with an acid-proof, protective material. The glass is then immersed in the chemical treatment solution for etching, after which the protective material is removed. The etching reduces the thickness of the glass to about 0.1 mm to 0.4 mm. After joining the two panels, a lighting system called a backlight is attached to complete the manufacture of the liquid crystal display 100.

Now, the following will describe concrete examples of the lighting system which are suitable to the present invention. The present invention is however not limited to the arrangement of the lighting system discussed below; any changes may be made where necessary.

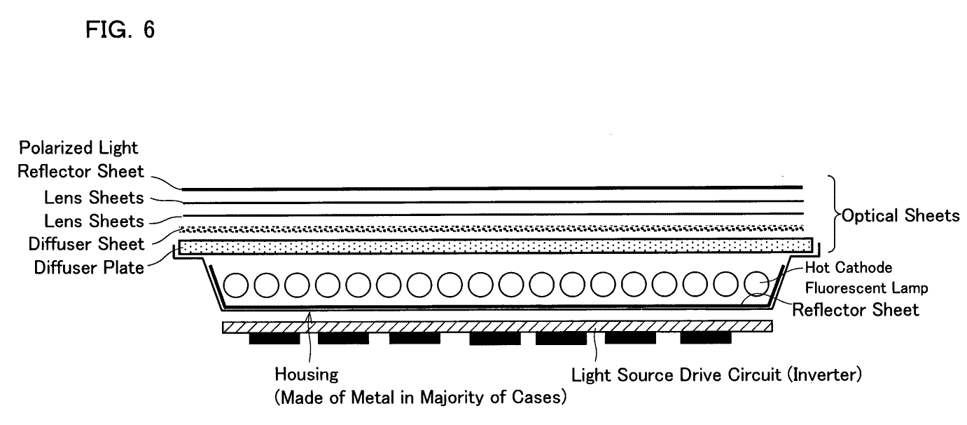

The liquid crystal display 100 of the present invention, due to its display mechanism, needs a more powerful backlight than conventional panels. In addition, the display 100 absorbs notably more of short wavelengths than conventional panels; the light source should be a blue one that emits more intense light at short wavelengths. FIG. 6 shows an example of the lighting system which meets these conditions.

Hot cathode fluorescent lamps are used for the liquid crystal display 100 of the present invention to obtain luminance similar to conventional panels. The prominent feature of the hot cathode fluorescent lamp is that it outputs about 6 times as intense light as a cold cathode fluorescent lamp with typical specifications.

Taking a 37-inch WXGA-format display as an example of the standard liquid crystal display, 18 of the lamps are arranged on an aluminum housing. Each lamp has an external diameter (=φ) of 15 mm. The housing includes a white reflector sheet made of resin foam for efficient usage of the light emitted backward from the lamps. The power supply for the lamps is provided on the back of the housing to drive the lamps on the household power supply.

Next, a translucent white resin plate is necessary to eliminate images of the lamps in the housing because the lamps are used for direct backlighting. A 2-mm thick plate member made primarily of polycarbonate is placed on the housing for the lamps. Polycarbonate exhibits high resistance to wet warping and heat deformation. On top of the member are provided optical sheets (namely, from the bottom, a diffuser sheet, two lens sheets, and a polarized light reflector sheet), so as to achieve predetermined optical effects. With these specifications, the backlight is about 10 times as bright as typical conventional specifications: i.e., 18 cold cathode fluorescent lamps (φ=4 mm), two diffuser sheets, and a polarized light reflector sheet. The 37-inch liquid crystal display of the present invention is hence capable of about 400 cd/m² luminance.

The backlight discharges as much as 5 times more heat than a conventional backlight. The heat is progressively discharged to air from a fin and forcefully ejected through air flow created by a fan, both being provided on the back of the back chassis.

The mechanical members of the lighting system double as major mechanical members for a whole liquid crystal module. The backlight is attached to the fabricated panels which already have a complete set of components mounted thereto. A liquid crystal display controller (including panel drive circuits and signal distributors), a light source power supply, and in some cases a general household power supply are also attached to completes the manufacture of the liquid crystal module. The backlight is attached to the fabricated panels which already have a complete set of components mounted thereto, and a framework is disposed to hold the panels together. That completes the manufacture of the liquid crystal display of the present invention.

The present embodiment uses a direct backlighting system using a hot cathode fluorescent lamp. Alternatively, the lighting system, depending on application, may be of a projection type or an edge-lit type. The light source may be cold cathode fluorescent lamps, LEDs, OELs, or electron beam fluorescence tubes. Any optical sheets may be selected for a suitable combination.

In the embodiment above, the slits are provided in the pixel electrodes of the active matrix substrate, and the alignment controlling projections are provided on the color filter substrate, so as to control the alignment direction of the vertical alignment liquid crystal molecules. As another embodiment, the slits and projections may be transposed. Furthermore, slits may be provided in the electrodes of both substrates. An MVA liquid crystal panel may be used which has alignment controlling projections on the surfaces of the electrodes of both the substrates.

Besides the MVA type, a pair of vertical alignment films may be used which establish orthogonal pre-tilt directions (alignment treatment directions). Alternatively, VA mode in which liquid crystal molecules are twist-aligned may be used. VATN mode, mentioned earlier, may also be used. VATN mode is preferable in the present invention because contrast is not reduced by the light leaking through the alignment controlling projections. The pre-tilt is established by, for example, optical alignment.

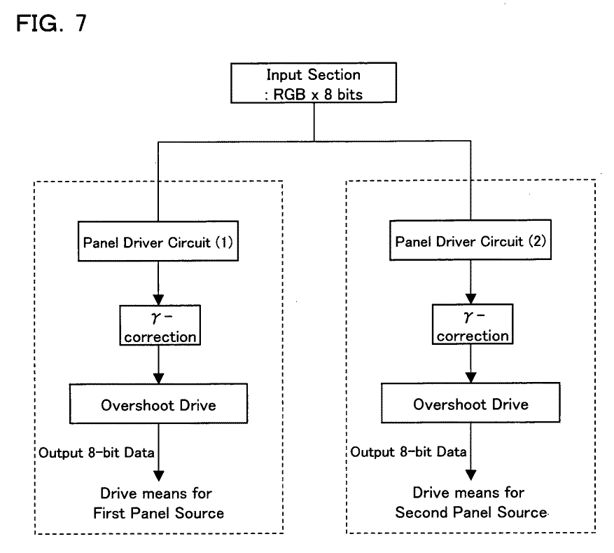

Referring to FIG. 7, the following will describe a concrete example of a driving method implemented by the display controller of the liquid crystal display 100 constructed as above. Assume 8-bit (256 gray levels) inputs and 8-bit liquid crystal drivers.

The panel drive circuit (1) in the display controller section performs γ-correction, overshooting, and other drive signal processing on input signals (video source) to output 8-bit gray level data to a source driver (source drive means) for the first panel.

Meanwhile, the panel drive circuit (2) performs γ-correction, overshooting, and other signal processing to output 8-bit gray level data to a source driver (source drive means) for the second panel.

Both the first and second panels are able to handle 8-bit data; the resultant output is 8-bit images. The output and input signals have a one-to-one relationship. Input signals are faithfully reproduced.

According to patent document 7, when the gray level changes from a low to a high, the gray level on each panel does not increase continuously. For example, when the luminance increases from 0 to 1, 2, 3, 4, 5, 6, . . . , the gray levels on the first and second panels change from (0, 0) to (0, 1), (1, 0), (0, 2), (1, 1), (2, 0). . . Thus, the gray level on the first panel changes from 0 to 0, 1, 0, 1, 2. The gray level on the second panel changes from 0 to 1, 0, 2, 1, 0. Neither gray levels increase monotonously. However, overdrive and many other signal processing technologies for liquid crystal displays require that gray level changes to be monotonous because the technologies use algorithm which involves interpolation calculations. To handle the non-monotonous changes, all the gray level data should be stored in memory. That may lead to increased circuit complexity and cost for display control circuitry and ICs.

Joining the first and second panels as described above leads to flickering which is attributable to various factors.

The present invention will discuss anti-flickering schemes for two combined panels in the following embodiments.

### EMBODIMENT 1

Causes of flickers in the liquid crystal display panel will be described first.

The liquid crystal display panel is driven by dot-reversal drive to display a black and gray checker board pattern as shown in FIG. 17 to examine flickering. The luminance of the liquid crystal display panel changes every frame as shown in FIG. 18. The repeated changes between high/low levels of luminance lead to flickers appearing on the screen of the liquid crystal display panel. In addition, if the liquid crystal panel has non-uniform properties, flickering shows local variations.

If the liquid crystal panel has non-uniform properties, the areas where flickering occurs change by changing the common voltage (Vcom) applied to the liquid crystal display panel.

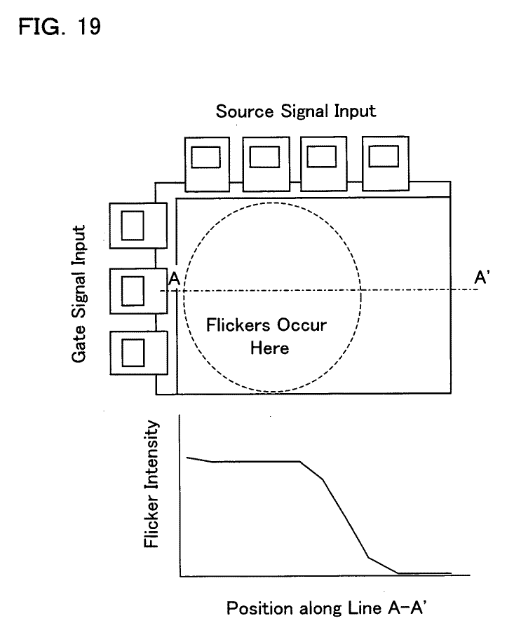

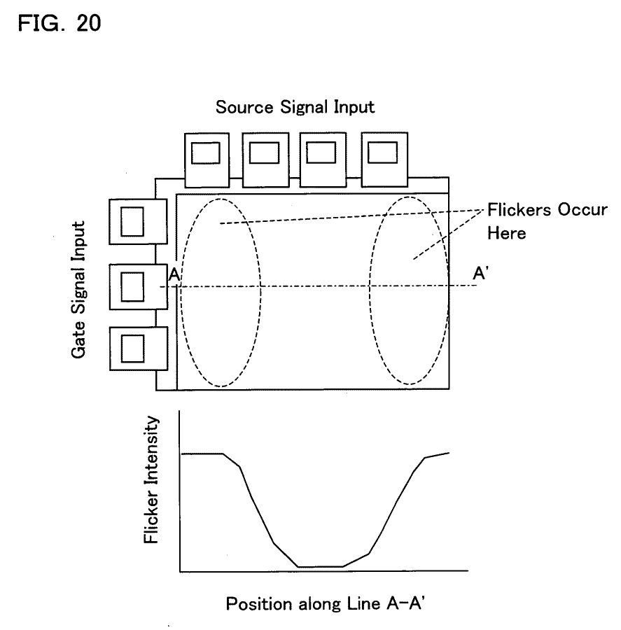

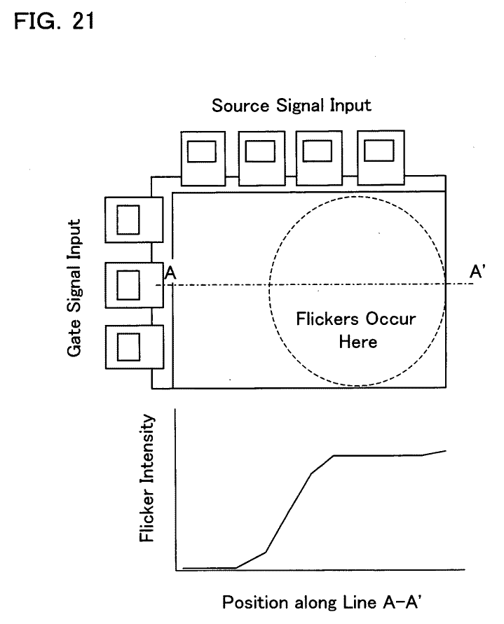

In an equivalent circuit, each pixel of the liquid crystal module is represented by an capacitor, and a wire in a panel by a resistor. The capacitor and resistor forms a RC transmission path; the electrical properties of the panel depend on the distance from drive means. For example, when Vcom is 4 V, flickering occurs near the side where gate signals are supplied (near the drivers) as shown in FIG. 19; when Vcom is 5 V, flickering occurs on both sides of the liquid crystal display panel as shown in FIG. 20; and when Vcom is 6 V, flickering occurs opposite the side where gate signals are supplied as shown in FIG. 21.

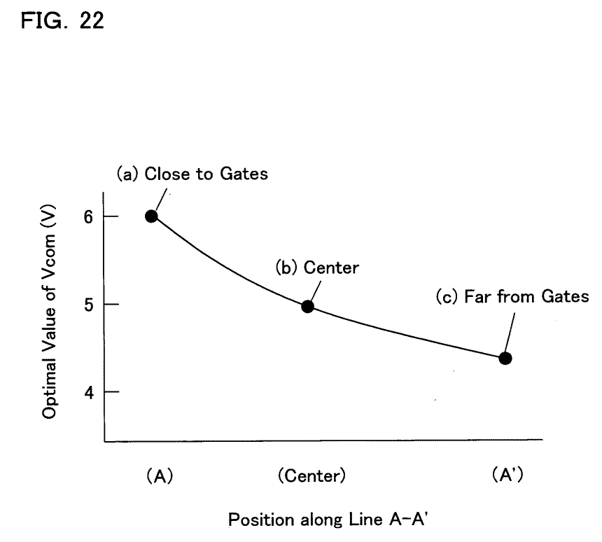

The graph in FIG. 22 demonstrates that optimal values of Vcom are dependent on on-screen positions.

Changing the value of Vcom generally results in moving flicker-free areas like these examples. Due to the resistance of the wiring and the capacitance of the liquid crystal, however, there is no single optimal value for Vcom at which no flickering occurs across the display screen.

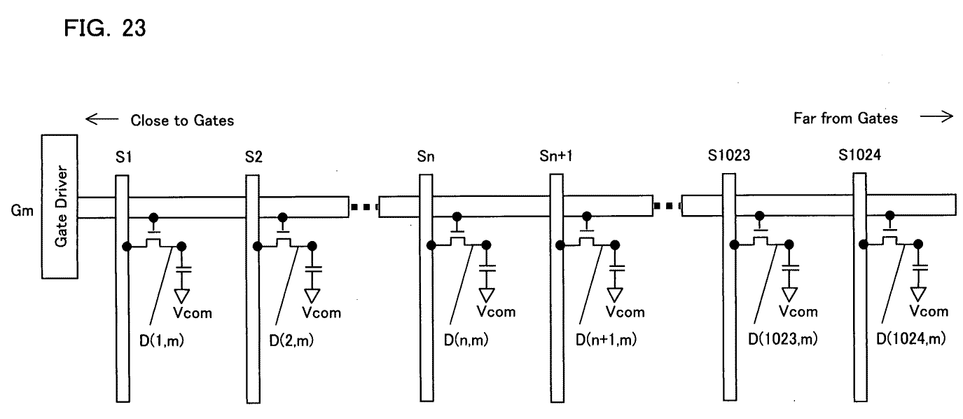

The following will describe reasons for the lack of single optimal value for Vcom in reference to the equivalent circuit to pixels shown in FIG. 23.

The gate input pulse signal delays as the signal moves away from the gate input (near the far end) due to the loads connected to the gate wires (resistance and stray capacitance) as shown in FIG. 23.

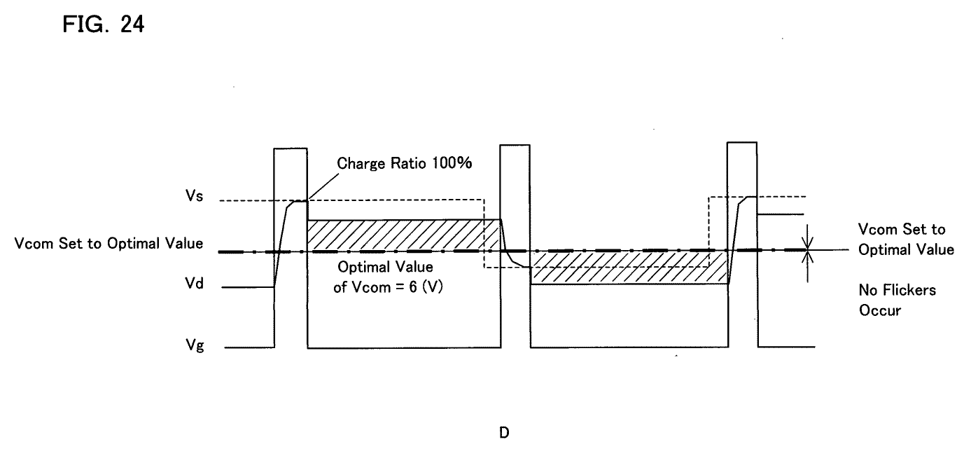

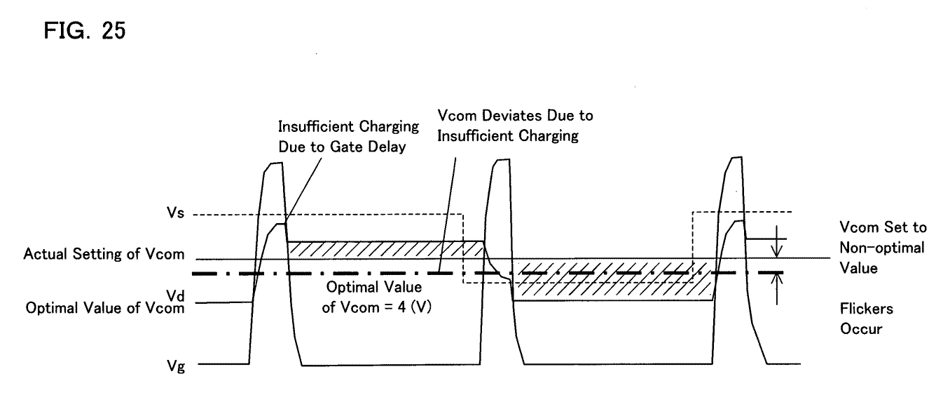

If Vcom is set to 6 V as an example, no flickering occurs at the near end because the charge ratio for the drain voltage (Vd) is 100% as shown in FIG. 24. In contrast, at the far end, the drain ratio for the drain voltage (Vd) is insufficient; a deviation develops in the optimal Vcom value between the near end and the far end as shown in FIG. 25. If Vcom is set to the optimal value for the near end, the Vcom value setting differs from the optimal value at the far end, which in turn causes flickering.

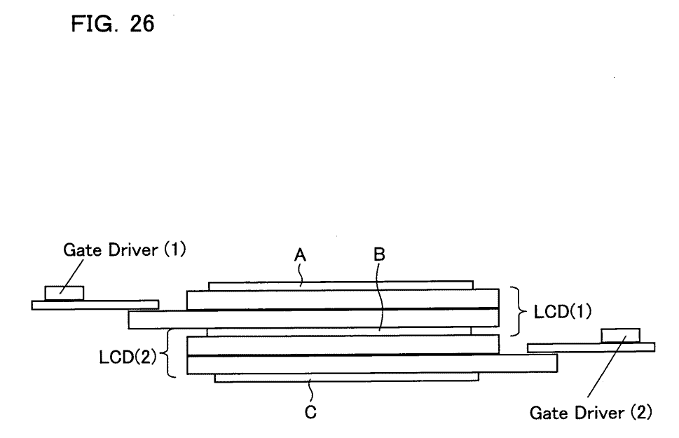

Accordingly, the inventors have found that in a liquid crystal display containing a pair of stacked liquid crystal display panels which are a basic configuration for the present invention, flickers cancel out, hence disappear, by disposing two sets of gate drivers oppositely across the screen as shown in FIG. 26 so that gate signals are fed to the two liquid crystal display panels from opposite directions.

The liquid crystal display shown in FIG. 26 include stacked liquid crystal panels (LCD (1), LCD (2)) containing polarized light absorbing layers. Pairs of adjacent polarized light absorbing layers of the liquid crystal panels (polarizers A, B, C) form crossed Nicols. When the first liquid crystal panel (LCD (1)) produces a display from a first display signal, the other liquid crystal panel (LCD (2)) produces a display from a second display signal derived from the first display signal. Sets of structural elements (gate drivers (1), gate drivers (2)), one for the display produced by the first liquid crystal panel (LCD (1)) and another for the display produced by the second liquid crystal panel (LCD (2)) from the second display signal are laid out in symmetry.

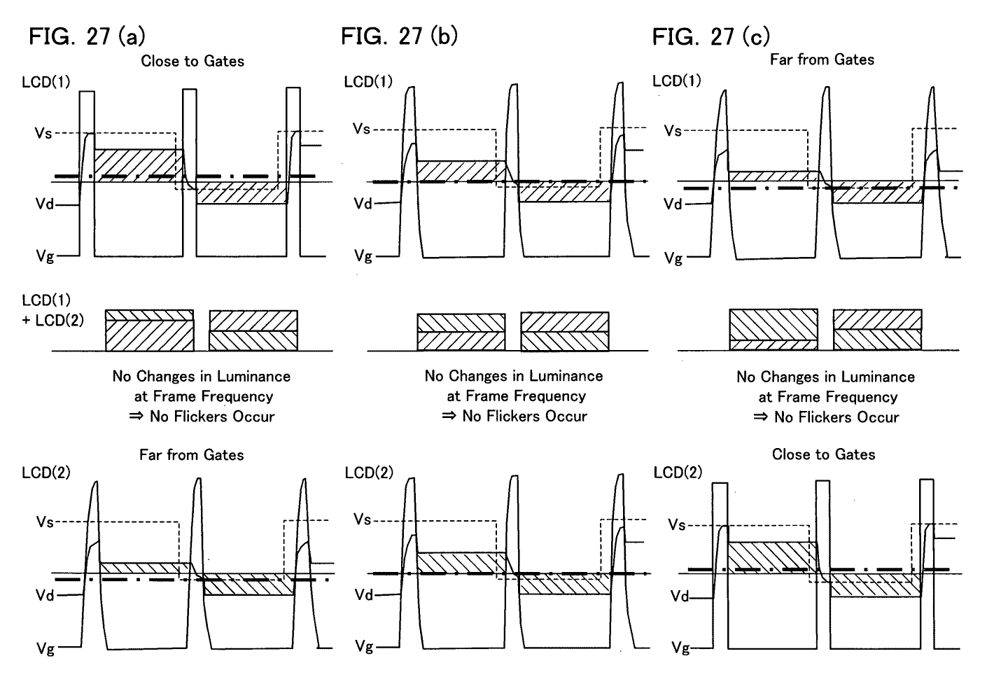

With these settings, flickers cancel out between the signal waveforms at the near end, the center, and the far end of two liquid crystal display panels (LCD (1), LCD (2)) in the liquid crystal display as shown in FIGS. 27(a) to 27(c).

The following will describe a specific example of a liquid crystal display in which flickering is restrained.

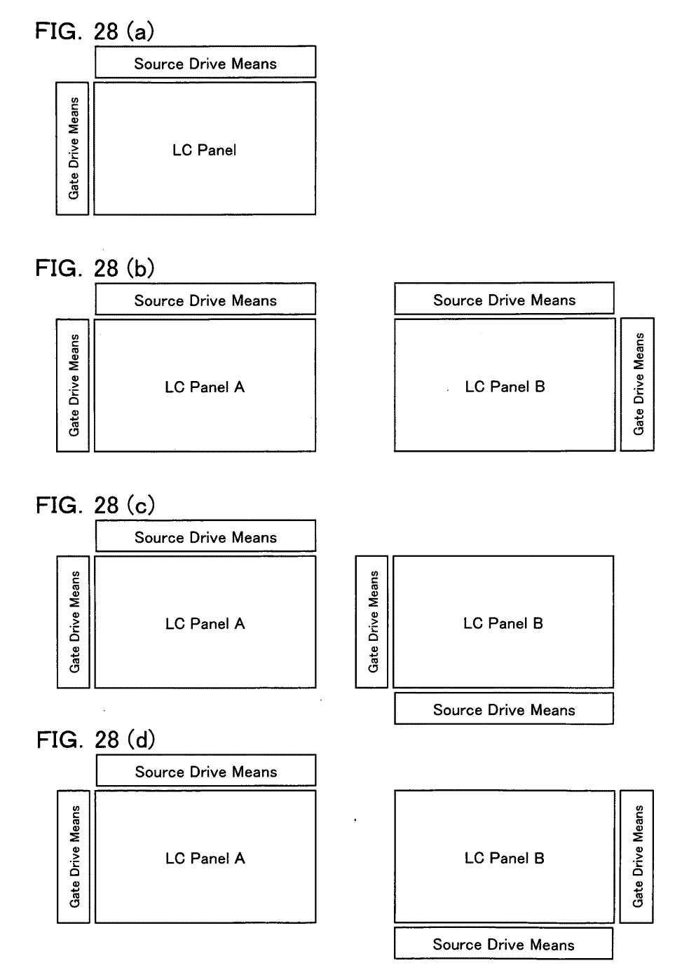

Referring to FIG. 28(a), for example, if the liquid crystal module is operated with all the source drivers disposed on one end and all the gate drivers disposed on one side, the source bus lines and the gate bus lines are all driven only in single directions, creating a slope in driving property distribution. The “slope” refers to signals being delayed opposite the end/side where gate signals and source signals are supplied.

The problem is addressed by stacking the two liquid crystal panels so that they are symmetric with respect to the y-axis as shown in FIG. 28(b). Arranging the gate drive means symmetric with respect to the y-axis mitigates the property slope along the horizontal direction. Accordingly, the two panels cancel out the delays of the gate signals, thereby restraining flickering.

Likewise, due to the resistance of the source bus lines and the capacitance of the liquid crystal, a similar property slope exists. The problem is addressed by stacking the two liquid crystal panels so that they are symmetric with respect to the x-axis as shown in FIG. 28(c). Arranging the source drive means symmetric with respect to the x-axis mitigates the property slope along the vertical direction. Accordingly, the two panels cancel out the delays of the source signals, thereby restraining flickering.

Furthermore, by stacking the two liquid crystal panels symmetric with respect to a point, that is, by arranging the gate drive means symmetric with respect to the y-axis and arranging the source drive means symmetric with respect to the x-axis, as shown in FIG. 28(d), the horizontal and vertical property slopes are mitigated. Accordingly, the panels cancel out the delays of the source and gate signals, thereby restraining flickering.

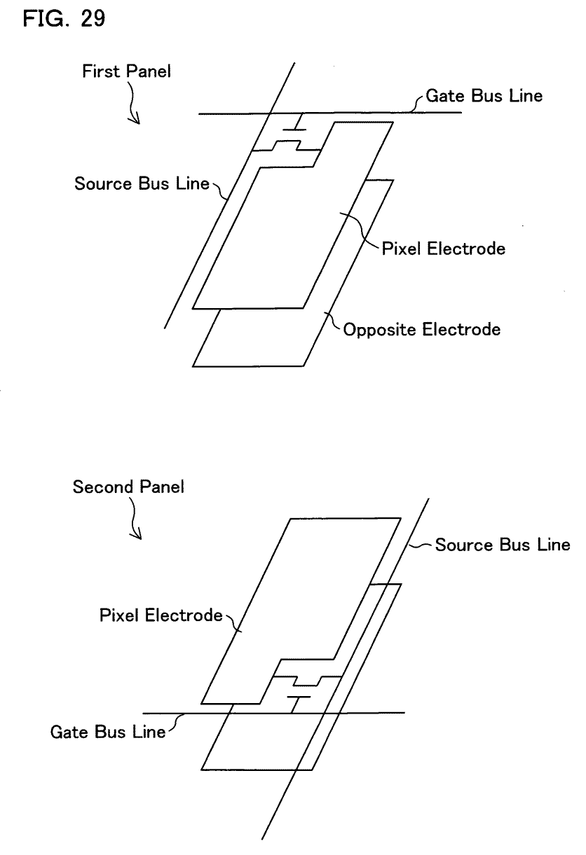

Typically, the liquid crystal pixels are very small in size, and the liquid crystal pixel electrodes are affected via stray capacitance by the source bus lines, the gate bus lines, and the TFT elements which are located in close proximity as shown in FIG. 29.

If the layout of the gate drive means and the source drive means is changed as shown in FIGS. 28(b) to 28(d), pixels are arranged differently in the liquid crystal panel A and in liquid crystal panel B. As a result, all the pixels are affected equally by the source bus lines, etc., which improves uniformity across the screen.

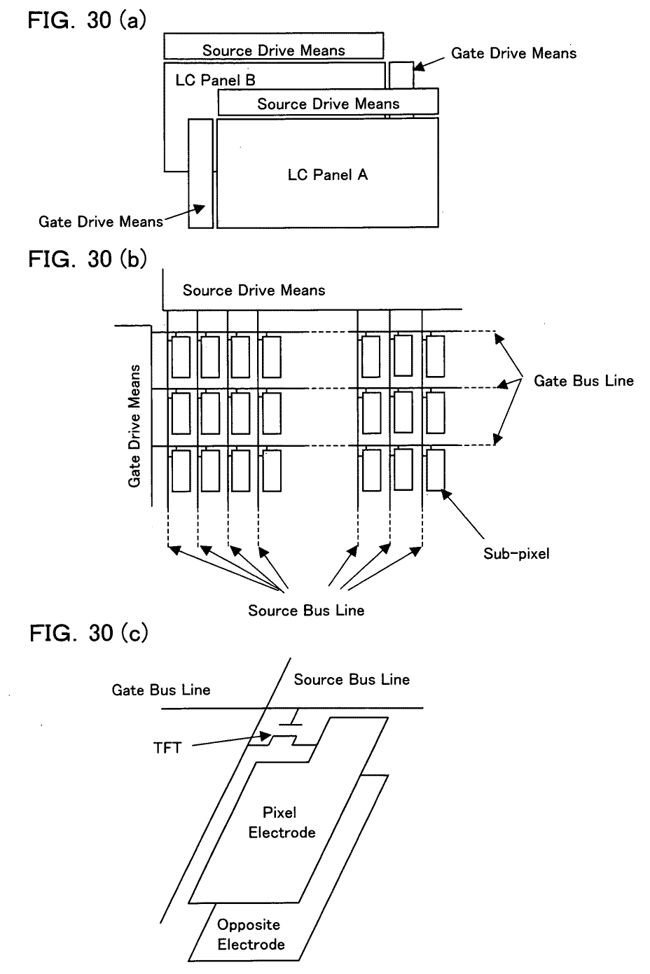

For example, if the liquid crystal panel A and the liquid crystal panel B are combined together so that the gate drive means are symmetric with respect to the y-axis as shown in FIG. 30(a), the liquid crystal panel contains, on the TFT side, subpixels formed where the gate bus lines from the gate drive means intersect the source bus lines from the source drive means as shown in FIG. 30(b).

Each subpixel contains as shown in FIG. 30(c), a pixel electrode and an opposite electrode. The pixel electrode is connected to a TFT element provided at the intersection of a gate bus line and a source bus line.

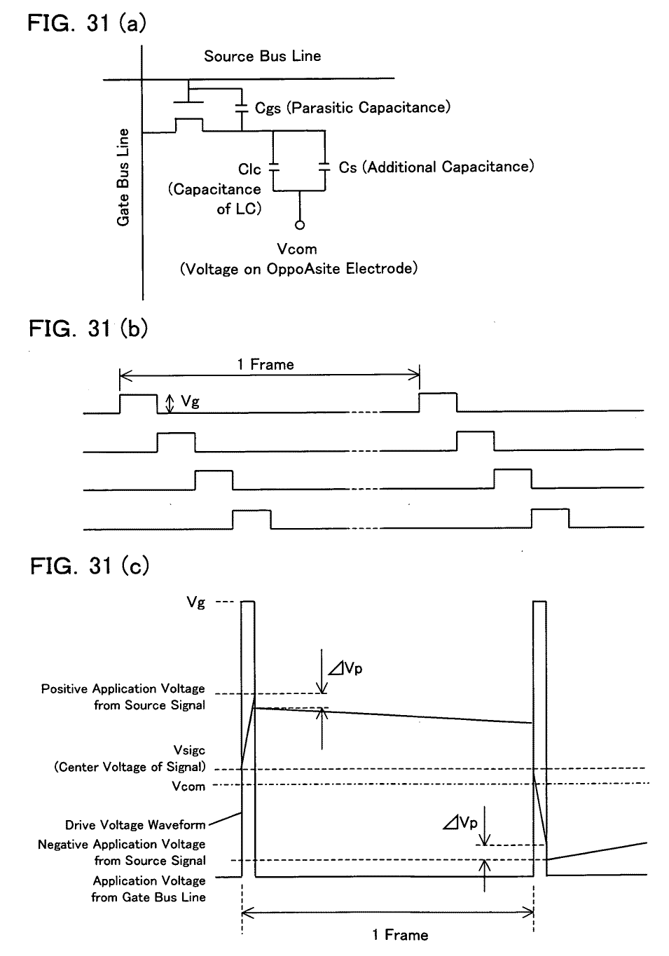

FIG. 31(a) shows an equivalent circuit to the subpixel. In the equivalent circuit, a gate voltage with a waveform shown in FIG. 31(b) is applied to the gate bus line, a drive voltage is generated with a waveform shown in FIG. 31(c).

The presence of Cgs (parasitic capacitance) and Cs (additional capacitance) results in undesirable variations in the drive voltage (=ΔVp); the value of Vcom applied to the opposite electrode is shifted from the center of the positive application voltage and the negative application voltage. Due to the shifting, the amount of charge under positive application (when positive voltage is applied) equals the amount of charge under negative application (when negative voltage is applied). As a result, DC voltage application to the liquid crystal is prevented, and the luminance under positive application equals the luminance under negative application. That restrains flickering.

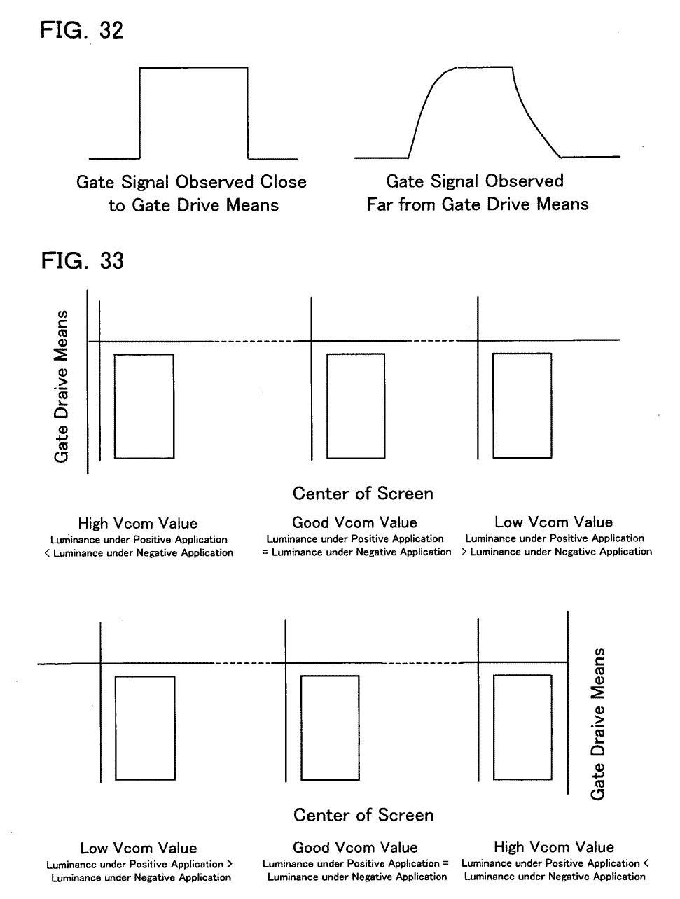

Each gate bus line is a set of wires in the panel and has a resistance. Each liquid crystal subpixel can be represented by a capacitor in an equivalent circuit as shown in FIG. 31(a). Therefore, the gate bus line acts as a RC-distributed constant circuit. If a rectangle wave is fed to the circuit from the gate drive means, the waveform is distorted as it moves away from the gate drive means through the bus lines, as shown in FIG. 32. The waveform distortion reduces ΔVp, thereby changing the optimal value for Vcom.

Since all the subpixels share a common value of Vcom, if Vcom is adjusted to a suitable value for the center of the screen, Vcom becomes higher than the optimal value near the gate drive means. Therefore, the amount of charge, hence luminance, is greater under negative application than under positive application. Conversely, Vcom becomes lower than the optimal value away from the gate drive means. Therefore, the amount of charge, hence luminance, is greater under positive application than under negative application. In other words, the luminance difference under positive application and under negative application causes flickering.

Accordingly, disposing the gate drive means on the opposite panel on an end opposite the gate bus lines as shown in FIG. 33 cancels out the luminance of the liquid crystal panel A and the luminance of the liquid crystal panel B under positive application and under negative application. That reduces flickering.

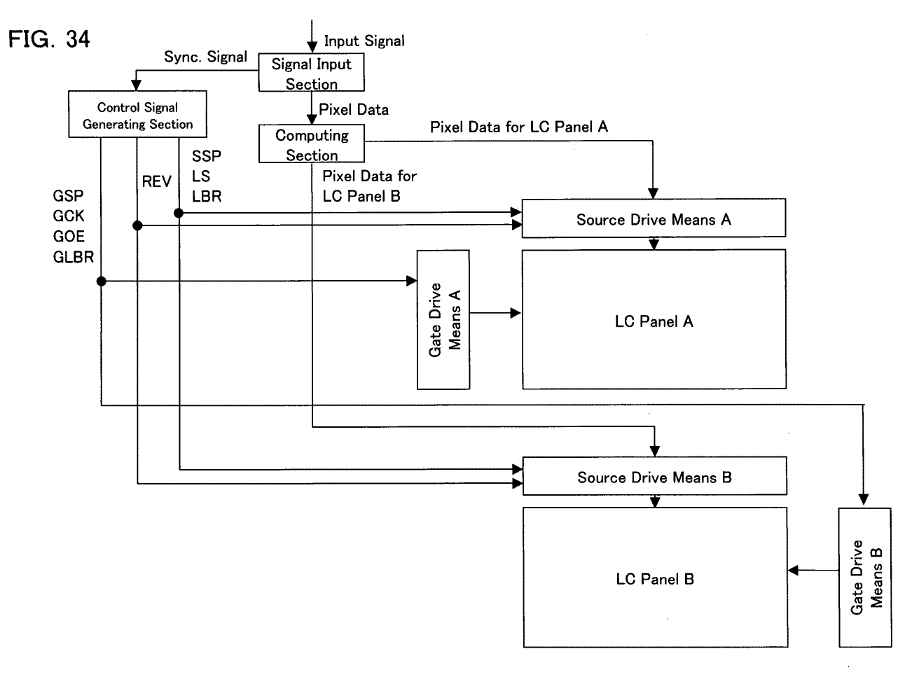

FIG. 34 shows a block diagram of a liquid crystal display in which the occurrences of flickering are lowered.

The liquid crystal display in FIG. 34 includes a signal input section, a computing section, a control signal generating section, a source drive means A, a gate drive means A, a source drive means B, and a gate drive means B to drive the two liquid crystal panels.

The signal input section separates incoming data into a signal synchronization component and pixel data. The computing section generates pixel data for the liquid crystal panel A and the liquid crystal panel B from incoming data.

The control signal generating section generates control signals for the source drive means and the gate drive means from incoming synchronous signal.

The source drive means A, B drive the source bus lines of the liquid crystal panels A, B.

The gate drive means A, B drive the gate bus lines of the liquid crystal panels A, B.

The source drive means receive the following signals as source drive signals:

SSP (source start pulse): A signal indicating the start of a set of pixel data for one row.

LS: A signal indicating a timing of switching between source outputs.

LBR: A signal by which to control the direction of source signal scanning.

REV: A signal by which to control the polarity of source outputs.

The gate drive means receive the following signals as gate drive signals:

GSP (gate start pulse): A signal indicating the start of a set of pixel data for one column.

GCK: A signal indicating the shift clocking of the gates.

GOE: A mask signal for gate outputs.

GLBR: A signal by which to control the direction of gate scanning.

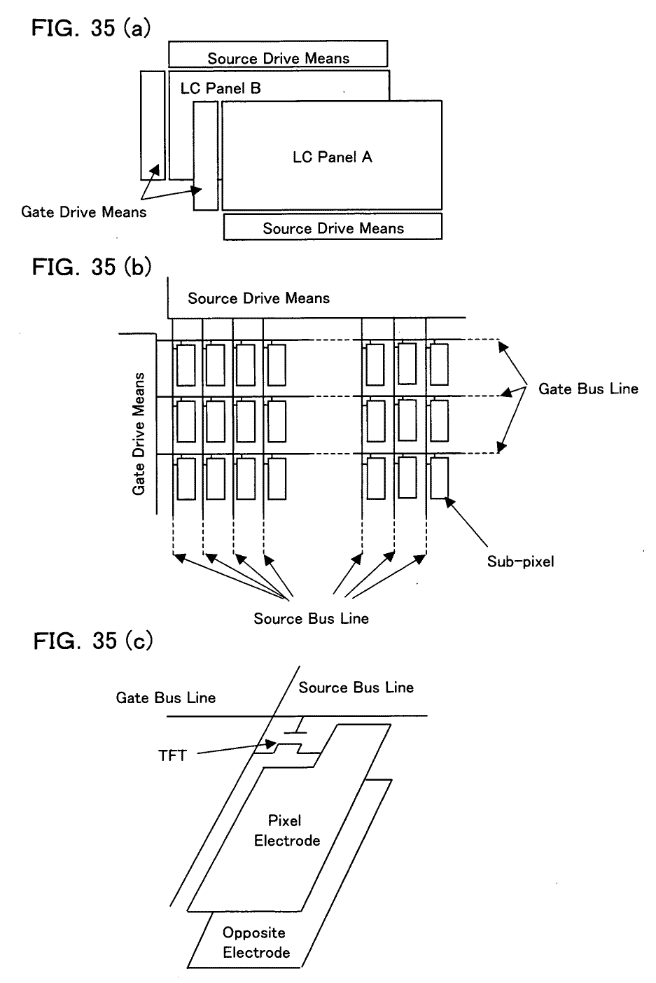

If the liquid crystal panel A and the liquid crystal panel B are combined together so that the source drive means are symmetric with respect to the x-axis as shown in FIG. 35(a), the liquid crystal panel contains, on the TFT side, subpixels formed where the gate bus lines from the gate drive means intersect the source bus lines from the source drive means as shown in FIG. 35(b).

Each subpixel contains, as shown in FIG. 35(c), a pixel electrode and an opposite electrode. The pixel electrode is connected to a TFT elements provided at the intersection of a gate bus line and a source bus line.

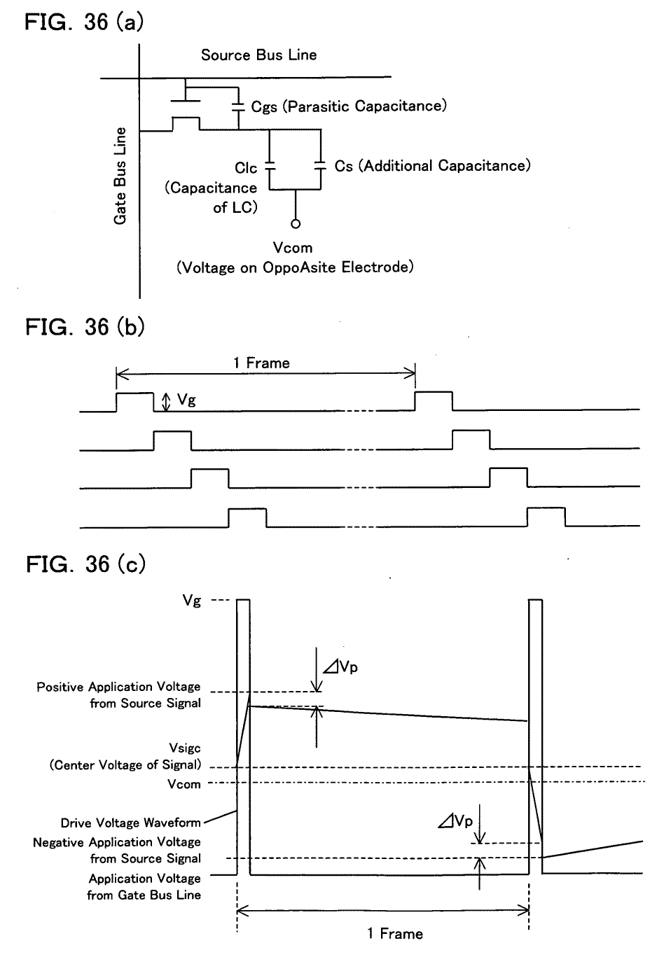

FIG. 36(a) shows an equivalent circuit to the subpixels. In the equivalent circuit, a voltage with a waveform shown in FIG. 36(b) is applied to the source bus line, a drive voltage is generated with a waveform shown in FIG. 36(c).

The presence of Cgs (parasitic capacitance) and Cs (additional capacitance) results in undesirable variations in ΔVp; the value of Vcom applied to the opposite electrode is shifted from the center of the positive application voltage and the negative application voltage. Due to the shifting, the amount of charge under positive application equals the amount of charge under negative application. As a result, DC voltage application to the liquid crystal is prevented, and the luminance under positive application equals the luminance under negative application. That restrains flickering.

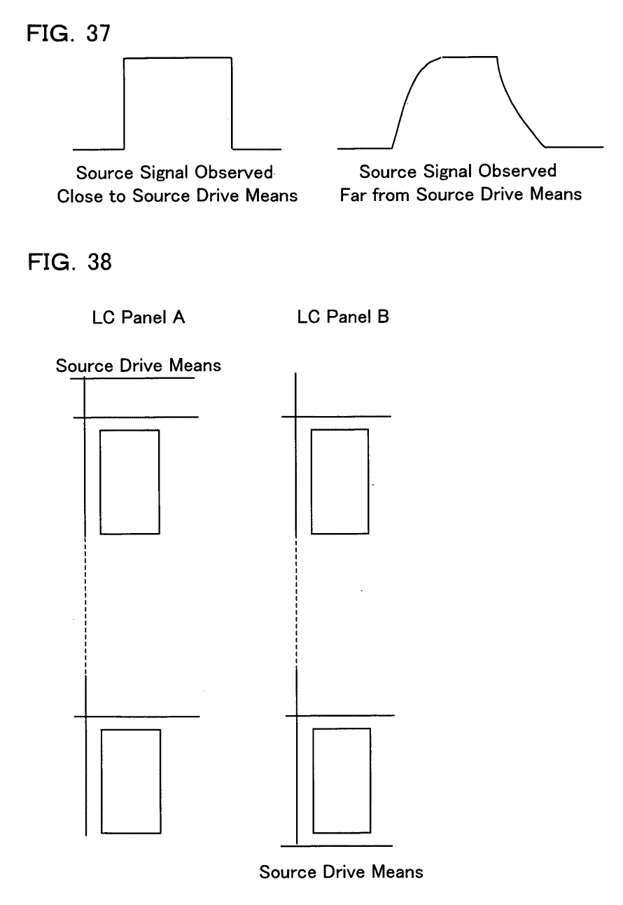

The source bus line is a set of wires in the panel and has a resistance. Each liquid crystal subpixel can be represented by a capacitor in an equivalent display as shown in FIG. 37(a). Therefore, the gate bus line acts as a RC-distributed constant circuit. If a rectangle wave is fed to the circuit from the source drive means, the waveform is distorted as it moves away from the source drive means through the bus lines, as shown in FIG. 38. The waveform distortion reduces ΔVp, thereby changing the optimal value for Vcom.

Since all subpixels share a common value of Vcom, if Vcom is adjusted to a suitable value for the center of the screen, Vcom becomes greater than the optimal value near the source drive means. Therefore, the amount of charge, hence luminance, is greater under negative application than under positive application. Conversely, Vcom becomes lower than the optimal value away from the source drive means. Therefore, the amount of charge, hence luminance, is greater under positive application than under negative application. In other words, the luminance difference under positive application and under negative application causes flickering.

Accordingly, disposing the source drive means on opposite panel on an end opposite the source bus lines as shown in FIG. 35(a) cancels out the luminance of the liquid crystal panel A and the luminance of the liquid crystal panel B under positive application and under negative application. That reduces flickering.

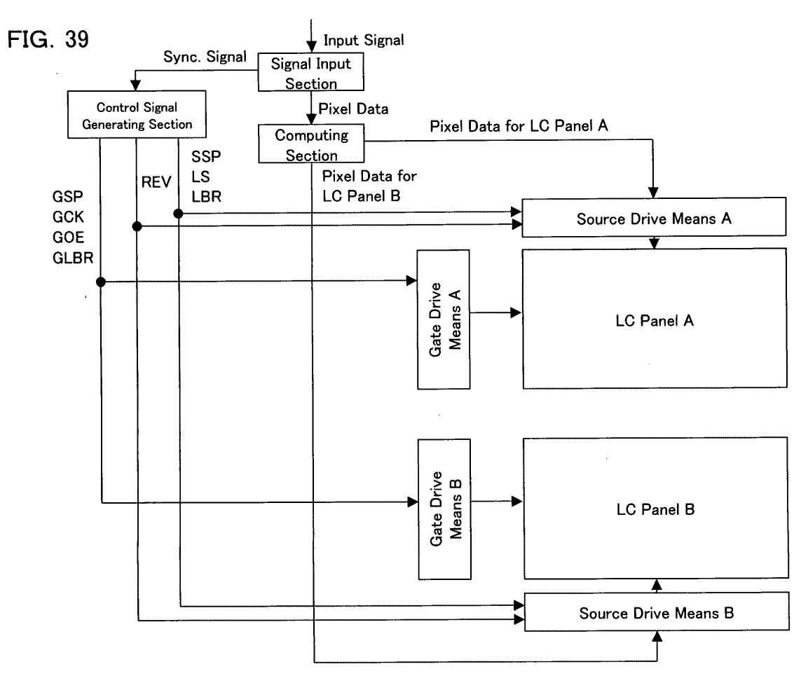

FIG. 39 shows a block diagram of a liquid crystal display in which the occurrences of flickering are lowered.

The liquid crystal display in FIG. 39 has the same structure as the liquid crystal display in FIG. 34, except that the source drive means and the gate drive means on the liquid crystal panel B are disposed at different places; no further description is given.

### EMBODIMENT 2

As described in embodiment 1, the dot-reversal drive scheme shown in FIGS. 17 and 18 cancels out flickering two-dimensionally, inevitably allowing a killer display pattern to persist. Flickering is not completely eliminated.

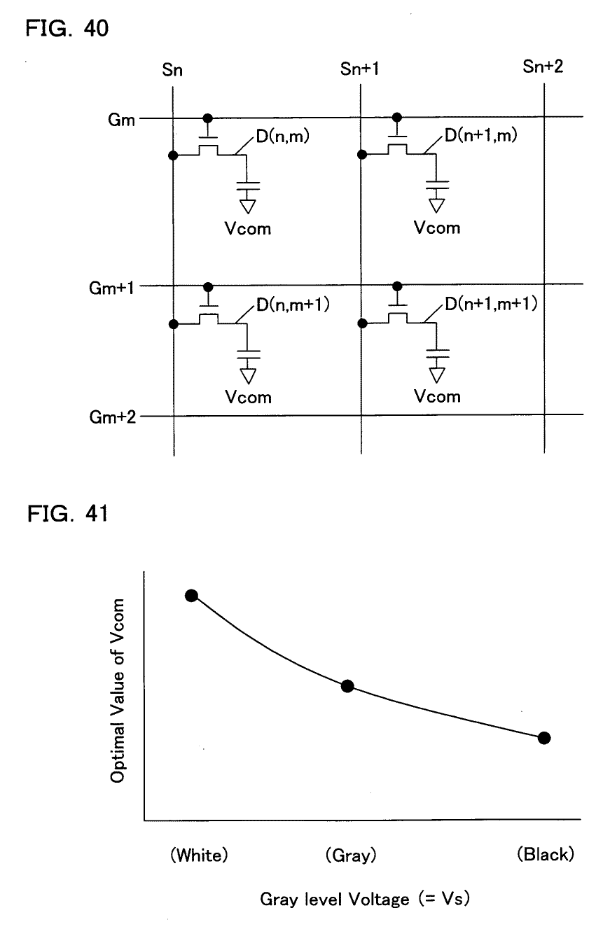

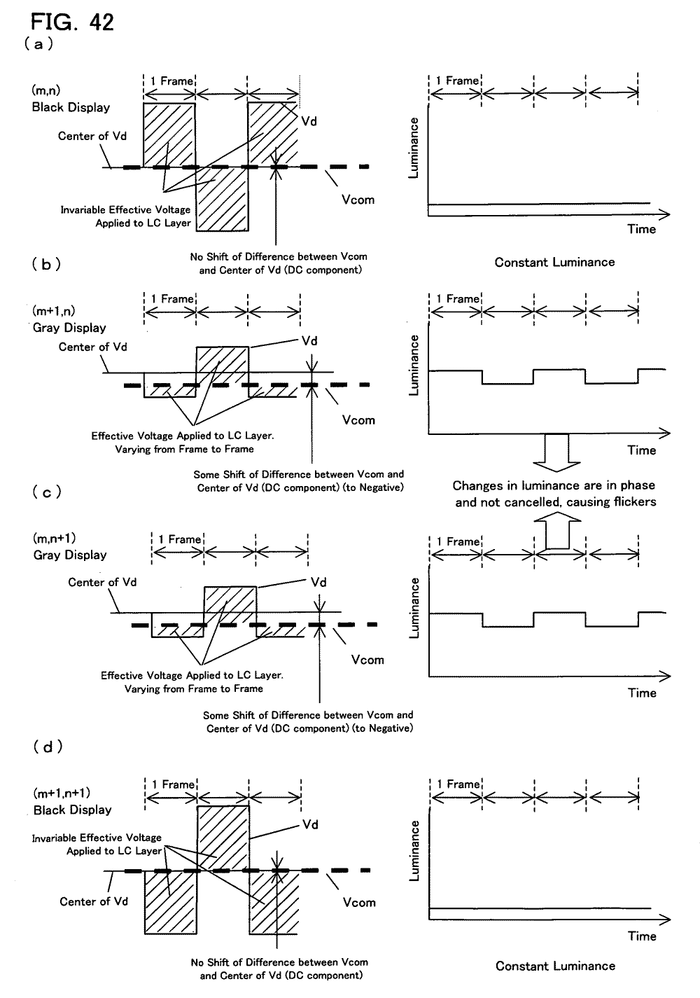

In an image equivalent circuit shown in FIG. 40, the TFT-LCD is known in theory to have characteristics (1), (2) below and therefore exhibit the optimal value of Vcom varying with gray level voltage as shown in FIG. 41.

(1) The charge ratio of a TFT changes with a difference between Vgh (“Hi” voltage of the gate pulse) and Vs (gray level voltage).

(2) The voltage holding ratio of a TFT changes with a difference between Vg1 (“Low” voltage of the gate pulse) and Vd (drain voltage).

Therefore, if the Vcom is set to an optimal level for black display, in gray-displaying pixels, the DC voltage due to the deviation of the value of Vcom is applied to the liquid crystal layer. As a result, luminance changes (flickers) occur at the frame cycle.

In this case, flickers occur due to the mechanism shown in FIGS. 41(a) to 41(d).

In other words, when a black display is being produced at coordinates (m,n), the effective voltage applied to the liquid crystal layer does not change as shown in FIG. 41(a), causing no deviation of the difference between Vcom and the center of Vd (DC component). Therefore, luminance is constant.

When a gray display is being produced at coordinates (m+1,n), the effective voltage applied to the liquid crystal layer changes for each frame as shown in FIG. 41(b), creating a deviation of the difference between Vcom and the center of Vd (DC component). Therefore, when the two panels are combined, changes in luminance on the panels occur in phase. Luminance changes cannot be cancelled out, resulting in flickering.

Likewise, when a gray display is being produced at coordinates (m,n+1), the effective voltage applied to the liquid crystal layer change for each frame as shown in FIG. 41(c), creating a deviation of the difference between Vcom and the center of Vd (DC component). Therefore, when two panels are combined, changes in luminance on the panels occur in phase. Luminance changes cannot be cancelled out, resulting in flickering.

When a black display is being produced at coordinates (m+1,n+1), the effective voltage applied to the liquid crystal layer does not change as shown in FIG. 41(d), causing no deviation of the difference between Vcom and the center of Vd (DC component). Therefore, luminance is constant.

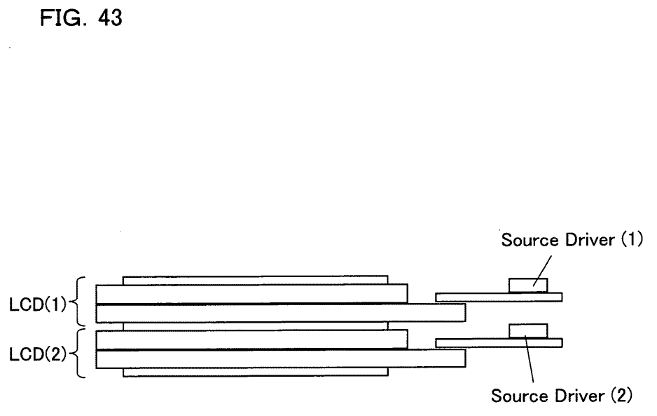

Accordingly, two liquid crystal display panels (LCD (1), LCD (2)) are combined as shown in FIG. 43, and source signals are applied to the LCD (1) and LCD (2) in opposite phase for the same pixels. The configuration restrains flickering. In the configuration, the source drive means are provided on the same side for the two liquid crystal display panels.

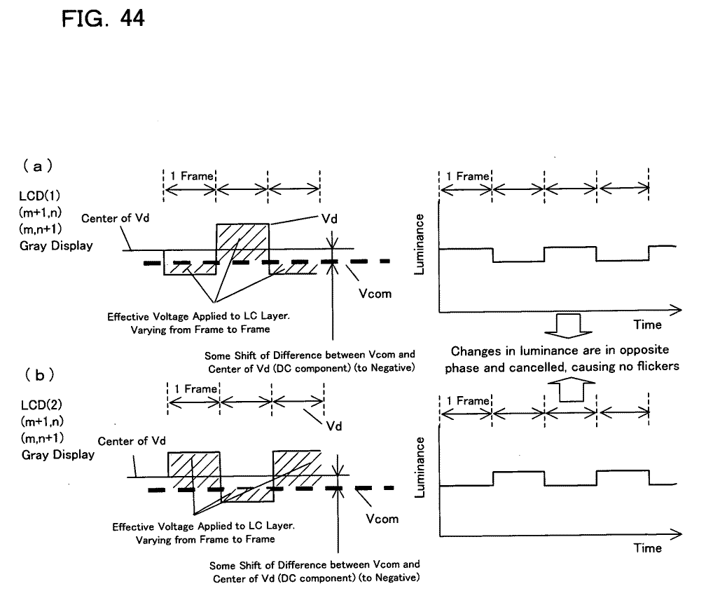

For example, the effective voltage applied to the liquid crystal layer changes for each frame at coordinates (m+1,n) and (m,n+1) of LCD (1) where a gray display being produced, creating a deviation of the difference between Vcom and the center of Vd (DC component). Likewise, the effective voltage applied to the liquid crystal layer changes for each frame at coordinates (m+1,n) and (m,n+1) of LCD (2) where a gray display is being produced, creating a deviation of the difference between Vcom and the center of Vd (DC component). However, as shown in FIG. 44, the source signals has phases of opposite polarities in LCD (1) and LCD (2); the changes in luminance are in opposite phases and cancelled out, thereby restraining flickering.

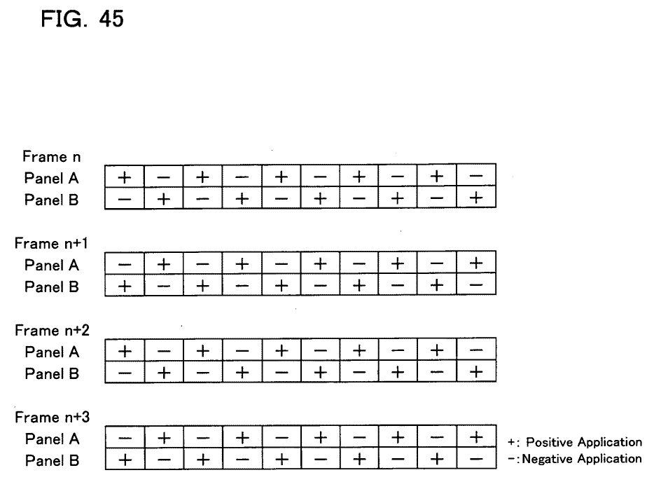

In other words, supposing that LCD (1) is the panel A and LCD (2) is the panel B, as shown in FIG. 45, driving is done so that the pixel application voltage for the upper panel and the pixel application voltage for the lower panel have opposite polarities in each frame. Flickering is thus reduced.

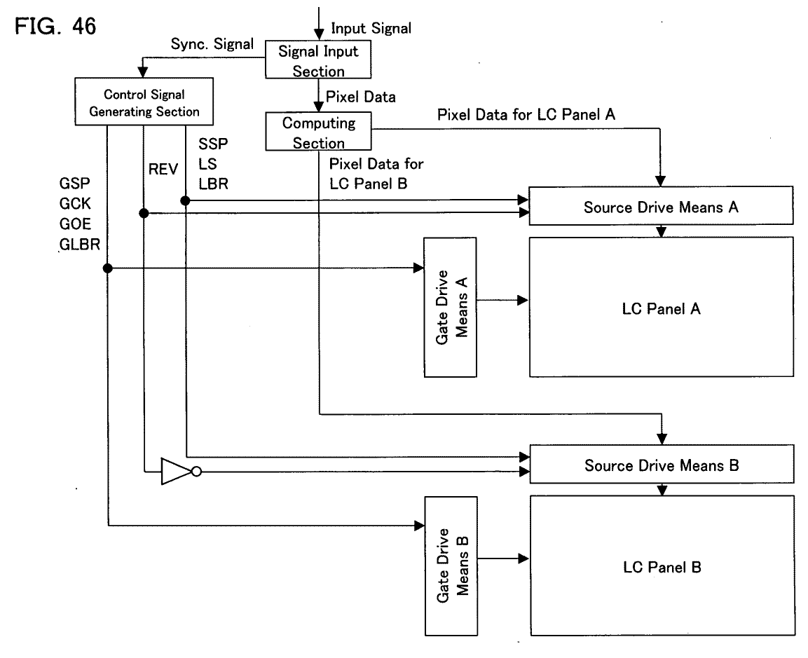

A concrete example of the liquid crystal display is shown in a block diagram in FIG. 46. Here, the figures shows the same individual means as those describe in embodiment 1 in reference to the block diagram in FIG. 34; no further description is given. It should be noted however that there is also provided an inverting means to change the polarity of the source signal fed to the source drive means B which drives the liquid crystal panel B as LCD (2).

### EMBODIMENT 3

Next will be described mounting of drive circuit boards when two liquid crystal display panels are stacked.

Drive circuit boards may be mounted by any of the following methods.

(1) Drive circuit boards are connected to the two liquid crystal display panels before combining the panels.

(2) The two liquid crystal display panels are combined first before drive circuit boards are connected to the panels.

Method (1) can be implemented using conventional devices and processes up to the connecting of circuit boards. The two panels however need to be combined after the drive circuit boards are connected. Therefore, workability is poor, and quality problems could occur (dust may attach).

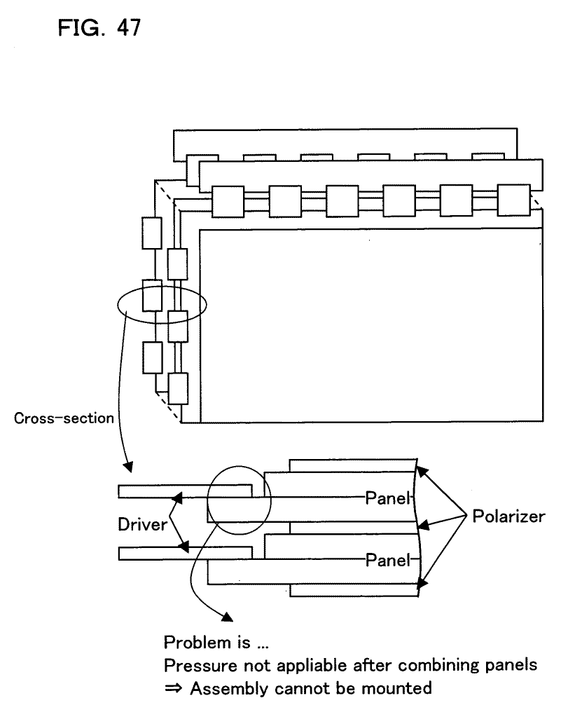

In contrast, method (2) may not cause quality problems. In the mounting, however, the boards must be connected to positions which overlap on the two panels. No backup can be used in thermocompression as shown in FIG. 47, which makes the connecting difficult.

The following will describe modifications to method (2) which enable use of a backup in thermocompression.

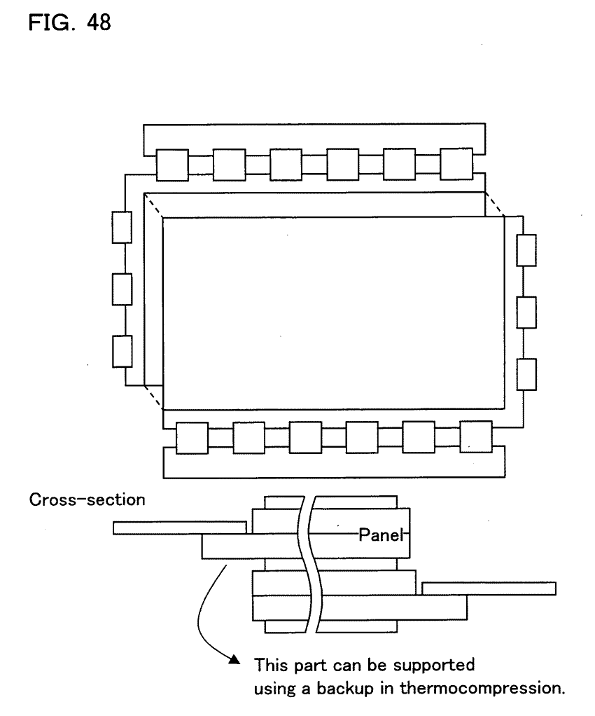

Method A: As shown in FIG. 48, the two panels are rotated 180° so that the driver connect sections do not overlap, enabling conventional connecting. According to the method, the four sides of the panels can be connected by a conventional connecting method.

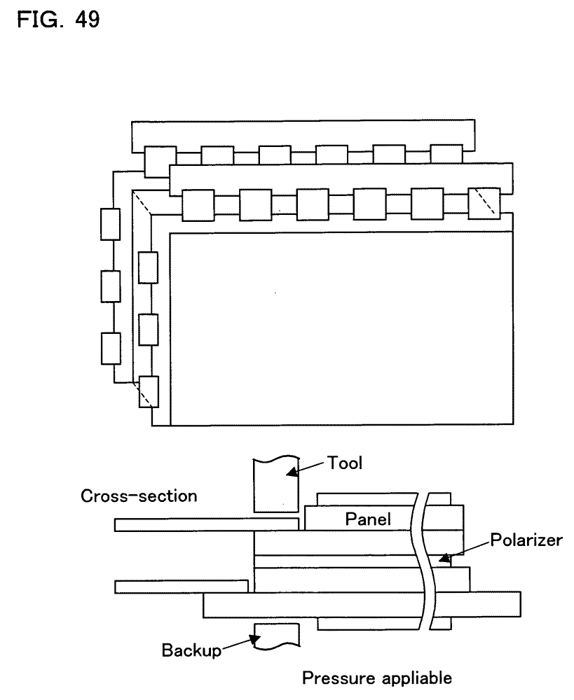

Method B: As shown in FIG. 49, the polarizer sandwiched between the panels is expanded to the size of the upper panel, and the lower panel is expanded, so that the positions of connections are moved. The method also allows application of pressure between a connecting tool and a backup, hence enabling normal connecting.

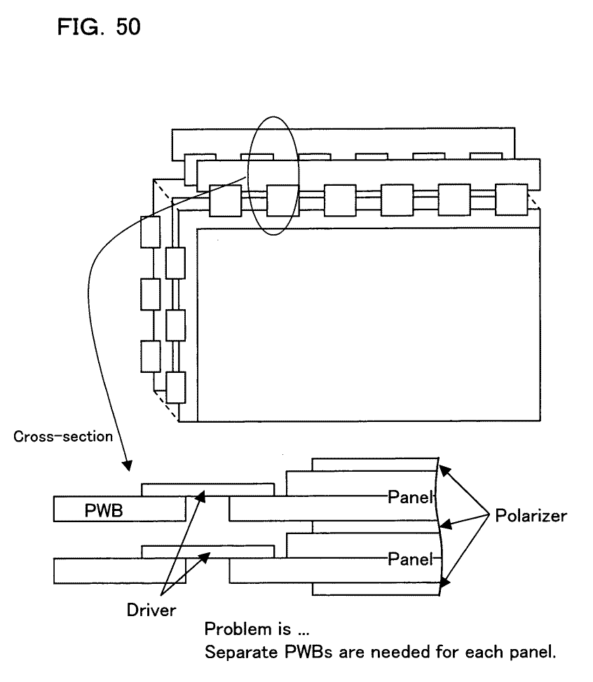

Meanwhile, if the polarizer sandwiched between the panels is expanded to the size of the upper panel, and the lower panel is expanded as in FIG. 49, the problems can be addressed on the gate driver side, but not on the source driver side where a backup in thermocompression cannot be used, making the connecting difficult. See FIG. 50.

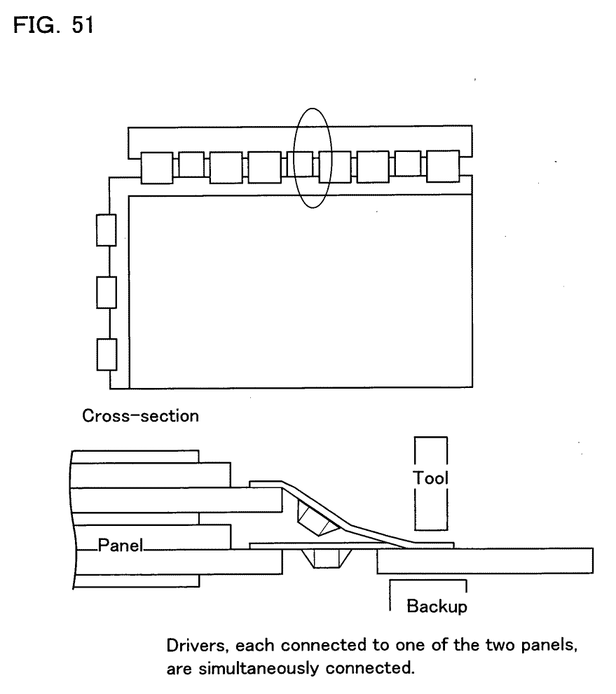

A possible solution may be such as arrangement as shown in FIG. 51 in which the drivers connecting to the two panels do not overlap and are connected simultaneously to a single circuit board. This method uses only one circuit board, enabling reduction in circuit board cost. In addition, the circuit board is fixed only once, which makes it easy to fix the circuit board and requires a fewer connecting steps.

### EMBODIMENT 4

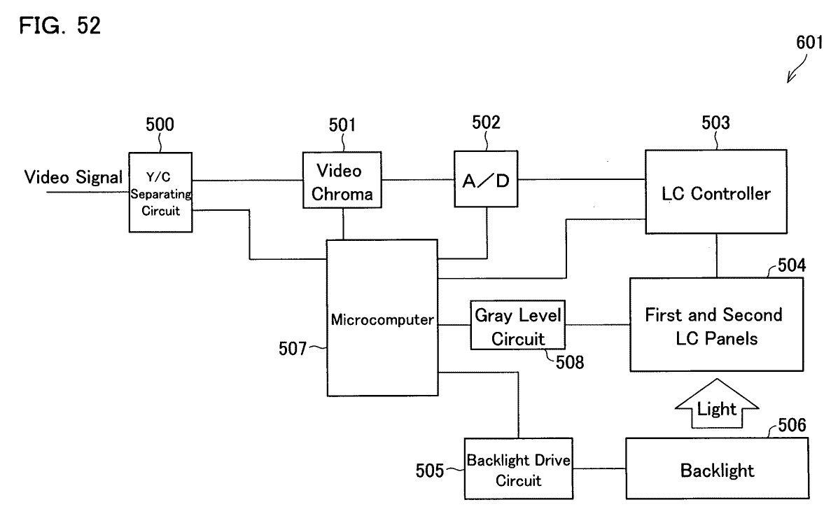

Referring to FIGS. 52 to 54, the following will describe an application of the liquid crystal display of the present invention to a television receiver.

FIG. 52 shows circuit blocks of a liquid crystal display 601 for the television receiver.

The liquid crystal display 601 includes, as shown in FIG. 52, a Y/C separating circuit 500, a video chroma circuit 501, an A/D converter 502, a liquid crystal controller 503, liquid crystal panels 504, a backlight drive circuit 505, a backlight 506, a microcomputer 507, and a gray level circuit 508.

The liquid crystal panels 504 has a double panel structure including a first liquid crystal panel and a second liquid crystal panel. The panels may be of any of the structures described in the foregoing embodiments.

In the liquid crystal display 601 arranged as above, first, an input video signal (television signal) is supplied to the Y/C separating circuit 500 where the signal is separated into a luminance signal and a color signal. The luminance and color signals are converted to R, G, B, or the three primary colors of light, in the video chroma circuit 501. Furthermore, the analog RGB signals are converted to digital RGB signals by the A/D converter 502 for output to the liquid crystal controller 503.

The liquid crystal panels 504 is fed with the RGB signals from the liquid crystal controller 503 at predetermined timings and also with RGB gray level voltages from the gray level circuit 508. From these signals, the panels 504 output images. The control of the whole system, including the foregoing processes, is performed by the microcomputer 507.

Various video signals may be used for display, including a video signal based on television broadcast, a video signal representing images captured on a camera, or a video signal fed over the Internet.

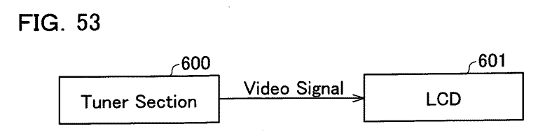

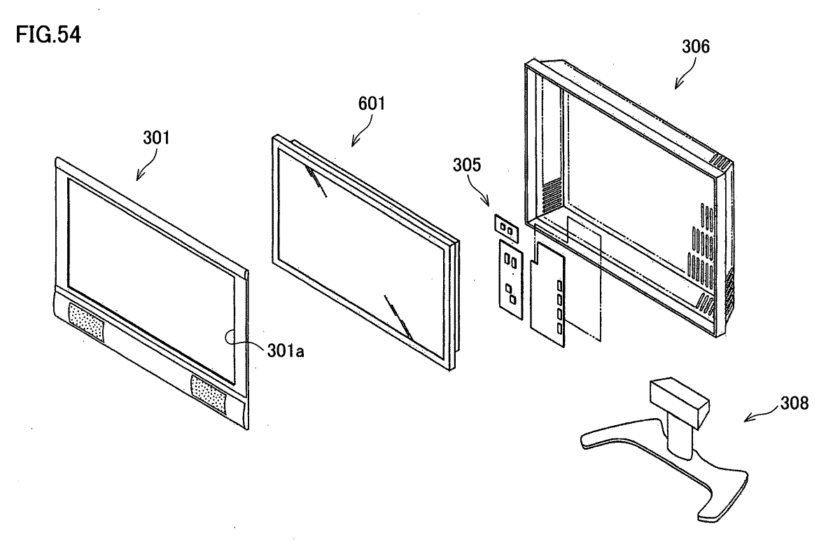

Furthermore, in FIG. 53, a tuner section 600 receives television broadcast and outputs a video signal. A liquid crystal display 601 displays images (video) based on the video signal supplied from the tuner section 600.

If the liquid crystal display arranged as above is a television receiver, for example, the display is structured so that the liquid crystal display 601 is sandwiched by and enclosed in a first housing 301 and a second housing 306 as shown in FIG. 54.

An opening 301a is formed through the first housing 301. The video display produced on the liquid crystal display 601 is visible through the opening 301a.

The second housing 306 provides a cover for the back of the liquid crystal display 601. The housing 306 is provided with an operation circuit 305 for operation of the liquid crystal display 601. The housing 306 has a support member 308 attached to its bottom.

Applying, as described in the foregoing, the liquid crystal display of the present invention to a monitor for the television receiver arranged as above enables the output of high quality, flicker free images.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The liquid crystal display of the present invention delivers greatly improved contrast and is therefore suitably applicable, for example, to television receiver and broadcast monitors.

1. A liquid crystal display, comprising two or more stacked liquid crystal panels,
wherein
at least some of structural elements involved in producing a display on a first liquid crystal panel and a second liquid crystal panel are disposed symmetric with respect to a point, a line, or a plane, where one of adjacent liquid crystal panels of the stacked liquid crystal panels is the first liquid crystal panel, and the other is the second liquid crystal panel.

2. The liquid crystal display of claim 1, wherein the first and second liquid crystal panels each have source drive means so positioned that the source drive means is symmetric when the first and second liquid crystal panels are stacked.

3. The liquid crystal display of either one of claims 1 2, wherein the first and second liquid crystal panels each have gate drive means so positioned that the gate drive means is symmetric when the first and second liquid crystal panels are stacked.

4. The liquid crystal display of claim 1, wherein the first and second liquid crystal panels each have pixel electrodes connected to pixels constituted by switching elements and other structural elements, the elements being so positioned that the elements are symmetric when the first and second liquid crystal panels are stacked.

5. The liquid crystal display of claim 1, wherein the first and second liquid crystal panels each have drivers so positioned that the drivers are on opposite sides or ends of the first and second liquid crystal panels when the first and second liquid crystal panels are stacked.

6. The liquid crystal display of claim 1, wherein the first liquid crystal panel is fed with a first display signal, and the second liquid crystal panel is fed with a second display signal, the first and second display signals having opposite phases.

7. A liquid crystal display, comprising two or more stacked liquid crystal panels,
wherein
a first liquid crystal panel produces a display from a first display signal, and
a second liquid crystal panel produces a display from a second display signal obtained from the first display signal, where one of adjacent liquid crystal panels of the stacked liquid crystal panels is the first liquid crystal panel, and the other is the second liquid crystal panel,
wherein
the first and second display signals have opposite phases.

8. The liquid crystal display of claim 1, wherein the stacked liquid crystal panels each include a polarized light absorbing layer, the layers forming crossed Nicols across the liquid crystal panels.

9. A television receiver, comprising:
a tuner section for receiving television broadcast; and
a display for displaying the television broadcast received by the tuner section,
the display being a liquid crystal display containing two or more stacked liquid crystal panels,
wherein
at least some of structural elements involved in producing a display on a first liquid crystal panel and a second liquid crystal panel are disposed symmetric with respect to a point, a line, or a plane, where one of adjacent liquid crystal panels of the stacked liquid crystal panels is the first liquid crystal panel, and the other is the second liquid crystal panel.

10. The liquid crystal display of claim 7, wherein the stacked liquid crystal panels each include a polarized light absorbing layer, the layers forming crossed Nicols across the liquid crystal panels.
